(19) United States
(12) Patent Application Publication
(10) Pub. No.: US 2026/0202939 A1
(43) Pub. Date: Jul. 16, 2026

(54) USING IN-APP GESTURES TO IMPLEMENT DEEP LINKS

(71) Applicant: Google LLC, Mountain View, CA (US)

(72) Inventors: Rupika Srivastava, London (GB); Adomas Paltanavicius, London (GB); Luís Fernando Dorelli de Abreu, London (GB)

(21) Appl. No.: 19/135,149

(22) PCT Filed: Dec. 7, 2023
(86) PCT No.: PCT/US2023/082811

§ 371 Date: Jun. 3, 2025

Related U.S. Application Data
(60) Provisional application No. 63/387,681, filed on Dec. 15, 2022.

(51) Int. Cl. G06F 3/0481; G06F 3/0484; G06F 3/0488; G06F 9/451; G06F 16/955

(52) U.S. Cl. CPC G06F 3/0481; G06F 3/0484; G06F 9/451; G06F 16/9566; G06F 3/0488

(57) ABSTRACT

A computing device may receive, from a first software application executing at the computing device, a deep link and may determine a second application to handle the deep link. The Computing device may, in response to determining tire second software application to handle the deep link, determine one or more interactions with a user interface of the second software application to navigate the user interface of the second software application to specific content of the second software application indicated by the deep link. The computing device may perform, without user interaction, the one or more interactions with the user interface of the second software application to navigate the user interface of the second software application to the specific content of the second software application indicated by the deep link.

This application claims the benefit of U.S. Provisional Patent Application No. 63/387,681, filed 15 Dec. 2022, the entire contents of which is incorporated herein by reference.

### BACKGROUND

A developer of a software application may implement deep link functionality that links to specific content in the software application. Implementing deep link functionality may enable users to easily navigate to a specific piece of content within the software application without having to search through the software application and without having to navigate back and forth between different screens of the software application. For example, a social media application may implement deep link functionality to enable another software application to deep link to specific social media posts in the social media application and/or to deep link to a new post functionality of the social media application.

### SUMMARY

In general, aspects of this disclosure are directed to techniques to enable a software application to support deep linking to specific content in the software application. A software application publishing platform, such as an app store, that publishes a software application for download by computing devices may inject code for supporting deep links in a software application. Such code may enable the software application to programmatically interact with the user interface of the software application to navigate the user interface and content of the software application. When the software application is installed on a computing device, the software application may handle a deep link to specific content in the software application by programmatically interacting with the software application's user interface in order to navigate the software application to the deep linked specific content in the software application. By injecting code for supporting deep links in a software application, the software application publishing platform may enable the software application to handle deep links without needing the developer of the software application to write code for the software application to handle deep links.

In some aspects, the techniques described herein relate to a method including: receiving, by one or more processors and from a first software application executing at the one or more processors, a deep link; determining, by the one or more processors, a second software application to handle the deep link; in response to determining the second software application to handle the deep link, determining, by the one or more processors, one or more interactions with a user interface of the second software application to navigate the user interface of the second software application to specific content of the second software application indicated by the deep link; and performing, by the one or more processors and without user interaction, the one or more interactions with the user interface of the second software application to navigate the user interface of the second software application to the specific content of the second software application indicated by the deep link.

In some aspects, the techniques described herein relate to a computing device including: a memory that stores instructions; and one or more processors that execute the instructions to: receive, from a first software application executing at the one or more processors, a deep link; determine a second software application to handle the deep link; in response to determining the second software application to handle the deep link, determine one or more interactions with a user interface of the second software application to navigate the user interface of the second software application to specific content of the second software application indicated by the deep link; and perform, without user interaction, the one or more interactions with the user interface of the second software application to navigate the user interface of the second software application to the specific content of the second software application indicated by the deep link.

In some aspects, the techniques described herein relate to a non-transitory computer-readable storage medium storing instructions that, when executed, cause one or more processors of a computing device to: receive, from a first software application executing at the one or more processors, a deep link; determine a second software application to handle the deep link; in response to determining the second software application to handle the deep link, determine one or more interactions with a user interface of the second software application to navigate the user interface of the second software application to specific content of the second software application indicated by the deep link; and perform, without user interaction, the one or more interactions with the user interface of the second software application to navigate the user interface of the second software application to the specific content of the second software application indicated by the deep link.

In some aspects, the techniques described herein relate to a method including: modifying, by one or more processors, a software application to specify deep links supported by the software application to specific content in the software application; and adding, by one or more processors, code to the software application to programmatically interact with a user interface of the software application to handle the deep links supported by the software application.

In some aspects, the techniques described herein relate to a computing system including: a memory that stores instructions; and one or more processors that execute the instructions to: modify a software application to specify deep links supported by the software application to specific content in the software application; and add code to the software application to programmatically interact with a user interface of the software application to handle the deep links supported by the software application.

In some aspects, the techniques described herein relate to a non-transitory computer-readable storage medium storing instructions that, when executed, cause one or more processors of a computing system to: modify a software application to specify deep links supported by the software application to specific content in the software application; and add code to the software application to programmatically interact with a user interface of the software application to handle the deep links supported by the software application.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example environment in which an example software application implements deep link functionality using in-app gestures, in accordance with one or more aspects of the present disclosure.

FIG. 2 is a block diagram illustrating an example computing device, in accordance with one or more aspects of the present disclosure.

FIG. 3 is a block diagram illustrating an example computing system, in accordance with one or more aspects of the present disclosure.

FIG. 4 is a conceptual diagram illustrating a software application interacting with an example user interface of the software application to handle a deep link, in accordance with aspects of the present disclosure.

FIG. 5 is a flowchart illustrating example operations of an example computing device, in accordance with one or more aspects of the present disclosure.

FIG. 6 is a flowchart illustrating example operations of an example computing system, in accordance with one or more aspects of the present disclosure. with one or more aspects of the present disclosure.

### DETAILED DESCRIPTION

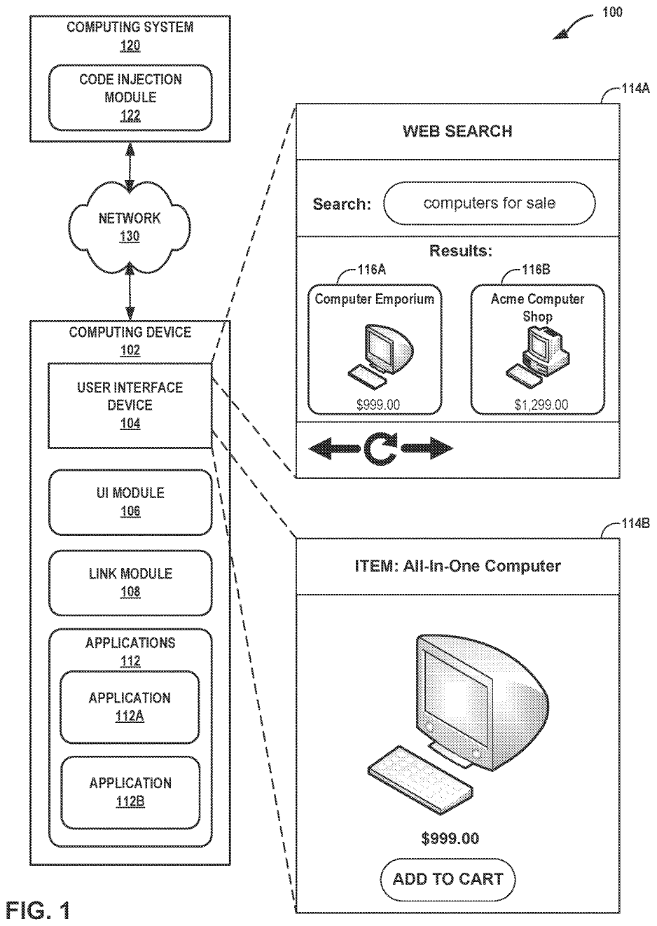

FIG. 1 is a conceptual diagram illustrating an example environment in which an example software application implements deep link functionality using in-app gestures, in accordance with one or more aspects of the present disclosure. As shown in FIG. 1, environment 100 includes computing device 102, computing system 120, and network 130.

Computing system 120 may represent any suitable computing system, such as one or more desktop computers, laptop computers, mainframes, servers, cloud computing systems, etc. capable of sending and receiving information both to and from a network, such as network 130. In some examples, the components of computing system 120 illustrated in FIG. 1 may reside and execute on the same or separate computing devices and systems operated by and/or under the control of one or more entities. In some examples, computing system 120 may represent one or more cloud computing systems that provide access to their respective services via a cloud.

Computing system 120 includes code injection module 122. Code injection module 122 may perform operations described herein using software, hardware, firmware, or a mixture of both hardware, software, and firmware residing in and executing on computing system 120 or at one or more other remote computing devices. In some examples, code injection module 122 may be implemented as hardware, software, and/or a combination of hardware and software. Computing system 120 may execute code injection module 122 with one or more processors. Computing system 120 may execute code injection module 122 as or within a virtual machine executing on underlying hardware. Code injection module 122 may be implemented in various ways. For example, code injection module 122 may be implemented as a downloadable or pre-installed application or “app.” In another example, code injection module may be implemented as part of an operating system of computing system 120. Other examples of computing system 120 implement techniques of this disclosure may include additional components not shown in FIG. 1.

Network 130 represents any public or private communications network, for instance, cellular, Wi-Fi, and/or other types of networks, for transmitting data between computing systems, servers, and computing devices, such as between computing system 120 and computing device 102. Network 130 may include one or more network hubs, network switches, network routers, or any other network equipment, that are operatively inter-coupled thereby providing for the exchange of information between computing system 120 and computing device 102. Computing device 102 and computing system 120 may transmit and receive data across network 130 using any suitable communication techniques. Each of computing system 120 and computing device 102 be operatively coupled to network 130 using respective network links, such as Ethernet, Wi-Fi, or any other types of wired and/or wireless network connections.

Computing device 102 represents an individual mobile or non-mobile computing device. Examples of computing device 102 include a mobile phone, a tablet computer, a laptop computer, a desktop computer, a server, a mainframe, a set-top box, a television, a wearable device (e.g., a computerized watch, computerized eyewear, computerized headphones, computerized gloves, etc.), a home automation device or system (e.g., an intelligent thermostat or home assistant device), a gaming system, a media player, an e-book reader, a mobile television platform, an automobile navigation or infotainment system, or any other type of mobile, non-mobile, wearable, and non-wearable computing device.

Computing device 102 includes a user interface device (UID) 104. UID 104 of computing device 102 may function as an input device for computing device 102 and as an output device for computing device 102. UID 104 may be implemented using various technologies. For instance, UID 104 may function as an input device using a presence-sensitive input screen, such as a resistive touchscreen, a surface acoustic wave touchscreen, a capacitive touchscreen, a projective capacitive touchscreen, a pressure sensitive screen, an acoustic pulse recognition touchscreen, or another presence-sensitive display technology. In some examples, UID 104 may function as an input device using one or more audio input devices, such as one or more microphones. UID 104 may function as an output (e.g., display) device using any one or more display devices, such as a liquid crystal display (LCD), dot matrix display, light emitting diode (LED) display, microLED, organic light-emitting diode (OLED) display, e-ink, or similar monochrome or color display capable of outputting visible information to a user of computing device 102. In some examples, UID 104 may function as an audio output device and may include one or more speakers, one or more headsets, or any other audio output device capable of outputting audible information to a user of computing device 102.

In some examples, UID 104 of computing device 102 may include a presence-sensitive display that may receive tactile input from a user of computing device 102. UID 104 may receive indications of the tactile input by detecting one or more gestures from a user of computing device 102 (e.g., the user touching or pointing to one or more locations of UID 104 with a finger or a stylus pen). UID 104 may present output to a user, for instance at a presence-sensitive display. UID 104 may present the output as a graphical user interface (e.g., user interface 140), which may be associated with functionality provided by computing device 102. For example, UID 104 may present various user interfaces of components of a computing platform, operating system, applications (e.g., software applications 112), or services executing at or accessible by computing device 102 (e.g., an electronic message application, an Internet browser application, a mobile operating system, etc.). A user may interact with a respective user interface to cause computing device 102 to perform operations relating to a function.

Computing device 102 includes user interface module 106 (“UI module 106”) and link module 108. Modules 106 and 108 may perform operations described herein using software, hardware, firmware, or a mixture of both hardware, software, and firmware residing in and executing on computing device 102 or at one or more other remote computing devices. In some examples, modules 106 and 108 may be implemented as hardware, software, and/or a combination of hardware and software. Computing device 102 may execute modules 106 and 108 with one or more processors. Computing device 102 may execute any of modules 106 and 108 as or within a virtual machine executing on underlying hardware. Modules 106 and 108 may be implemented in various ways. For example, any of modules 106 and 108 may be implemented as a downloadable or pre-installed application or “app.” In another example, any of modules 106 and 108 may be implemented as part of an operating system of computing device 102. Other examples of computing device 102 that implement techniques of this disclosure may include additional components not shown in FIG. 1.

UI module 106 may interpret inputs detected at UID 104. UI module 106 may relay information about the inputs detected at UID 104 to one or more associated platforms, operating systems, applications, and/or services executing at computing device 102 to cause computing device 102 to perform a function. UI module 106 may also receive information and instructions from one or more associated platforms, operating systems, applications, and/or services executing at computing device 102 (e.g., software applications 112) for generating a GUI. In addition, UI module 106 may act as an intermediary between the one or more associated platforms, operating systems, applications, and/or services executing at computing device 102 and various output devices of computing device 2 (e.g., speakers, LED indicators, vibrators, etc.) to produce output (e.g., graphical, audible, tactile, etc.) with computing device 102.

In the example of FIG. 1, one of software applications 112 may send data to UI module 106 that causes UID 104 to generate user interfaces and elements thereof. In response, UI module 106 may output instructions and information to UID 104 that cause UID 104 to display a user interface according to the information received from the application. When handling input detected by UID 104, UI module 106 may receive information from UID 104 in response to inputs detected at locations of a screen of UID 104 at which elements of the user interface are displayed. UI module 106 disseminates information about inputs detected by UID 104 to other components of computing device 102 for interpreting the inputs and for causing computing device 102 to perform one or more functions in response to the inputs.

Computing device 102 includes software applications 112 that include functionality to perform any variety of operations on computing device 102. For instance, software applications 112 may include a web browser, an email application, text messaging application, instant messaging application, weather application, video conferencing application, social networking application, e-commerce application, stock market application, emergency alert application, sports application, office productivity application, multimedia player, etc. Software applications 112 may perform operations described herein using software, hardware, firmware, or a mixture of both hardware, software, and firmware residing in and executing on computing device 102 or at one or more other remote computing devices. In some examples, software applications 112 may be implemented as hardware, software, and/or a combination of hardware and software. Computing device 102 may execute software applications 112 with one or more processors. Computing device 102 may execute any of software applications 112 as or within a virtual machine executing on underlying hardware. Software applications 112 may be implemented in various ways. For example, any of software applications 112 may be implemented as a downloadable or pre-installed application or “app.” In another example, any of software applications 112 may be implemented as part of an operating system of computing device 102. Other examples of computing device 102 that implement techniques of this disclosure may include additional components not shown in FIG. 1.

A software developer may write a software application to include functionality for handling deep links to specific content of the software application. Specific content of the software application may be a particular functionality of the software application, a particular activity or service of the software application, a specific screen of the user interface outputted by the software application, and the like. Deep links may be especially useful for linking to specific pieces of content within software applications executing at mobile computing devices because deep links may allow users to easily navigate to a specific piece of content within the software application without having to search through the software application and without having to navigate back and forth between different screens of the software application.

Deep links may be implemented using intents, which are messages that are sent between different components of software applications. When the user of a computing device selects a deep link, the computing device may attempt to find a software application installed at the computing device that can handle the selected deep link. If the computing device is able to find a software application that can handle the selected deep link, the computing device may open a piece of content in the software application indicated by the deep link.

Deep links may be in the form of a Uniform Resource Identifier (URI) or a Universal Resource Locator (URL) which may link to specific content of a software application and/or pass data to a software application. For example, a deep link to a social media application may be used to open the application and display a specific social media post or to open the application and allow a user to write a new post. In some examples, an example deep link of “myapp://product/12345” may open a Product activity in the software application associated with the URI scheme of “myapp” and display the product associated with a product identifier of 12345. In another example, an example deep link of “myapp://new/post?title=My % 20new %20post” may open a new post in the software application associated with the URI scheme of “myapp” that allows the user to write the new post with the title “My new post”.

In order to write a software application that can handle deep links, the software developer may have to add intent filters in the software application's manifest to specify the deep links handled by the software application, add code in the software application to handle the deep links specified in the manifest file, and create a digital asset links file on domains (e.g., websites) owned by the software developer. Due to the multi-step process that a software developer is required to perform to write software applications that include functionality for handling deep links, many software developers may refrain from developing software applications that include functionality for handling deep links to specific content of the software application.

In accordance with aspects of this disclosure, computing system 120 may modify a software application that does not include functionality for handling deep links to specific content of the software application so that the software application, after modification, includes functionality for handling deep links to specific content of the software application. In some examples, computing system 120 may be an application publishing platform that developers may submit software applications for listing in an app store, and computing system 120 may be able to modify a software application submitted by a developer without intervention of the developer or with minimal intervention of the developer to add functionality in the software application to handle deep links to specific content of the software application.

Code injection module 122 of computing system 120 may modify a software application by performing code injection to add code, such as executable code, object code, and the like to the software application that can execute to perform one or more actions to handle deep links to specific content in the software application. Code injection module 122 may add code that enables the software application to handle a deep link by programmatically interacting with the user interface of the software application to navigate to specific content in the software application indicated by deep links. For example, the added code may enable the software application to programmatically interact with user interface controls (e.g., buttons, menus, etc.), enter text into text fields (e.g., search fields), navigate through screens of the software application, and/or otherwise interact with the user interface of the software application without user input, in a similar fashion as a user may be able to by providing user input at an input device.

Such interactions with the user interface of a software application are referred to herein as gestures. For example, the added code may enable the software application to programmatically perform tap gestures to select buttons and text fields, programmatically perform swipe gestures and scrolling gestures, programmatically perform tap gestures to select keys of a virtual keyboard to enter text into text fields, and/or to programmatically perform any other gestures that can be performed by a user interacting with a computing device.

The code added to the software application by code injection module 122 may also include code to retrieve or otherwise determine the interactions with the user interface of the software application to perform to navigate to specific content in the software application indicated by deep links. That is, while the code added to the software application may be code that can be executed to programmatically perform any pattern or sequence of interactions with the user interface of the software application, such code may execute to receive an indication of a sequence of interactions with the user interface of the software application or to determine a sequence of interactions with the user interface of the software application in order to navigate the software application to the content specified by a deep link. The code added to the software application may therefore programmatically interact with the user interface of the software application according to the sequence of interactions in order to navigate to or otherwise surface the content specified by the deep link. In this way, the code added to the software application may be able to receive and perform a sequence of interactions that is specific to the software application in order to handle deep links.

Code injection module 122 may also modify the software application by modifying and/or creating the manifest of the software application, to declare the type of deep links that the software application can handle. That is, computing system 120 may generate and/or modify the manifest of the software application to declare the deep links handled by the software application and to associate the deep links handled by the software application with the code added by code injection module 122 to the software application.

In examples where deep links are in the form of a URI or a URL, computing system 120 may add, to the manifest of the software application, intent filters with paths and/or patterns of URIs and/or URLs handled by the software application. For example, code injection module 122 may specify, in the manifest of the software application, one or more domain names, such as “examplepetstore.com” or “altostrat.com,” to indicate that the software application is able to handle deep links that are web links to web sites at those one or more domain names.

Computing system 120 may determine, for a software application that is modified by computing system 120 to handle a deep link, one or more interactions with the user interface of the software application to perform an action to navigate to specific content of the software application specified by the deep link. For example, computing system 120 may crawl the user interface of the software application to identify user interface elements in the software application. Computing system 120 may also determine how to navigate the user interface of the software application to access and/or activate specific functionality of the software application. In some examples, computing system 120 may determine how to navigate the user interface of the software application to a search field in the user interface of the software application and to input text into the search field search for an item or content in the software application.

In this way, computing system 120 may be able to modify a software application to be able to handle deep links even if the software application, as written by the software developer, does not natively handle deep links. A computing system that is able to modify a software application to handle deep links may improve the field of software development by reducing the time and resources that a software developer may have to spend to write software applications that handle deep links.

A computing device, such as computing device 102, may have one or more applications that have been modified by computing system 120 to include code for handling deep links. For example, computing device 102 may download, from an app distribution system, such as computing system 120, via a network, such as network 130, software application 112B that has been modified by computing system 120 to include code for handling deep links.

In the example of FIG. 1, software application 112A may be a web browser application execute at computing device 102 as a foreground application of computing device 102. Software application 112A may output a graphical user interface by sending data to UI module 106 that causes UID 104 to generate user interface 114A and elements thereof for software application 112A. In response, UI module 106 may output instructions and information to UID 104 that cause UID 104 to display user interface 114A according to the information received from software application 112A.

User interface 114A may be a user interface of a web browser application that displays, in the example of FIG. 1, a web page for a search engine web site showing the results of performing a search for “computers for sale”. The results for the search may include web links 116A and 116B to e websites that are selling computers.

A web link is a hyperlink, such as in the form of a URL, that references a specific web page on a website that a user may provide user input to select to navigate a web browser application to the specific web page referenced by the web link. In some examples, software application 112A may, in response to the user selecting a web link, navigate to the web page referenced by the web link. The user of computing device 102 may interact with computing device 102, such as by providing user input at UID 104, to select a web link presented in user interface 114A by software application 112A. For example, the user of computing device 102 may provide user input at UID 104 that corresponds to selection of web link 116A, and computing device 102 may receive an indication of such a user input that corresponds to selection of web link 116A.

However, because a web link may also act as a deep link to specific content in another of software applications 112, software application 112A may, in response to computing device 102 receiving an indication of such a user input that corresponds selection of web link 116A, send an indication of the selected web link to link module 108 to determine whether the web link is a deep link that can be handled by another application of software application 112.

Link module 108 may receive the indication of the web link from software application 112A and may, in response, determine whether another application of software application 112 is able to handle the deep link. If link module 108 determines that another application of software application 112, is able to handle the deep link, link module 108 may pass the deep link to the application that is able to handle the deep link.

In some examples, each of software application 112 may specify the types of deep links to be performed that the respective application responds to. For example, each application may be associated with a manifest that lists the types of deep links that the respective application responds to. Link module 108 may be able to determine whether another application of software application 112 based on the manifests of each of software application 112. Each of software application 112 may specify the types of deep links that can be handled by the respective application, such as by including an intent filter with paths and/or patterns of deep links handled by the software application.

For example, a manifest of a software application may include an intent filter that specifies one or more domain names, which may indicate that the software application is able to handle deep links that are web links to web sites at those one or more domain names. Link module 108 may therefore, in the example of FIG. 1, determine, based on the domain name in the web link 116A received from software application 112A, that software application 112B is able to handle the web link 116A as a deep link because the manifest of software application 112B indicates a domain name that matches the domain name of the web link 116A.

In response to link module 108 determining that software application 112B is able to handle the deep link, software application 112B may execute as the foreground application of computing device 102 to handle the deep link. For example, computing device 102 may launch software application 112B as the foreground application of computing device 102 or may otherwise cause software application 112B to be the foreground application of software application 112B, and link module 108 may pass the deep link to software application 112B to handle.

Software application 112B may, in response to being launched and/or in response to becoming the foreground application of computing device 102, output a graphical user interface by sending data to UI module 106 that causes UID 104 to generate user interface 114B and elements thereof for software application 112B. In response, UI module 106 may output instructions and information to UID 104 that cause UID 104 to display user interface 114B according to the information received from the software application 112B.

Software application 112B may therefore receive the deep link from link module 108 and may execute code associated with handling of the deep link to navigate to the content of software application 112B specified by the deep link. As described above, the manifest of a software application may specify an association between a deep link handled by the software application and executable code, such as one or more functions, for handling the deep link. Because software application 112B includes code added by code injection module 122 of computing system 120 to handle deep links, software application 112B may execute such code added by code injection module 122 to handle the deep link.

Software application 112B may execute the code added by code injection module 122 to determine one or more interactions with user interface 114B of software application 112B to perform to navigate to the specific content of software application 112B specified by the deep link. In some examples, software application 112B may include an indication of one or more interactions with user interface 114B to navigate to the specific content of software application 112B specified by the deep link, such as in the application bundle of software application 112B. Such an indication of one or more interactions may be referred to as a gesture script.

In some examples, software application 112B may send a request to an external computing system (e.g., computing system 120) via a network (e.g., network 130) for one or more interactions with user interface 114B of software application 112B to perform to navigate to the specific content of software application 112B specified by the deep link and may, in response, receive from the external computing system via the network, an indication of one or more interactions with user interface 114B (e.g., a gesture script). For example, software application 112B may send a request that indicates the identity of software application 112B, an indication of the deep link (e.g., the URL of the deep link), or any other suitable information to the external computing system and may, in response, receive an indication of one or more interactions with user interface 114B to perform.

In some examples, software application 112B may also receive, from the external computing system, information extracted from the deep link that may be used by software application 112B to navigate to the specific content indicated by the deep link. For example, if the deep link includes an item number that may be used by software application 112B to search for the item in software application 112B, software application 112B may also receive, from the external computing system, the item number extracted from the deep link.

In some examples, software application 112B may send a request to the operating system of computing device 102 for one or more interactions with user interface 114B of software application 112B to perform to navigate to the specific content of software application 112B specified by the deep link and may, in response, receive from the operating system an indication of one or more interactions with user interface 114B (e.g., a gesture script). Such receipt of an indication of one or more interactions with user interface 114B may be referred to as gesture injection.

Software application 112B may, in response to determining the one or more interactions with the user interface 114B of software application 112B, execute the code added by code injection module 122 perform the one or more interactions with the user interface of software application 112B. Computing device 102 may programmatically perform the one or more interactions with the user interface 114B of software application 112B. That is, computing device 102 may automatically interact with the user interface of software application 112B to navigate to specific content of software application 112B without any user interactions with user interface 114B of software application 112B.

Software application 112B may therefore interact with the user interface 114B of software application 112B to navigate user interface 114B to the specific content of software application 112B specified by the deep link. For example, software application 112B may be able to select and/or deselect buttons in user interface 114B of software application 112B, input text into text fields of user interface 114B of software application 112B, scroll through lists in user interface 114B of software application 112B, perform gestures such as swiping gestures at user interface 114B of software application 112B, provide voice input such as voice commands at user interface 114B of software application 112B, or perform any other interactions with user interface 114B of software application 112B.

In this way, software application 112B may be able to navigate to the specific content indicated by the deep link. In the example of FIG. 1, if the deep link is a link to an item, such as a computer, being sold by an e-commerce store, software application 112B may be able to navigate to the product page of the item in software application 112B.

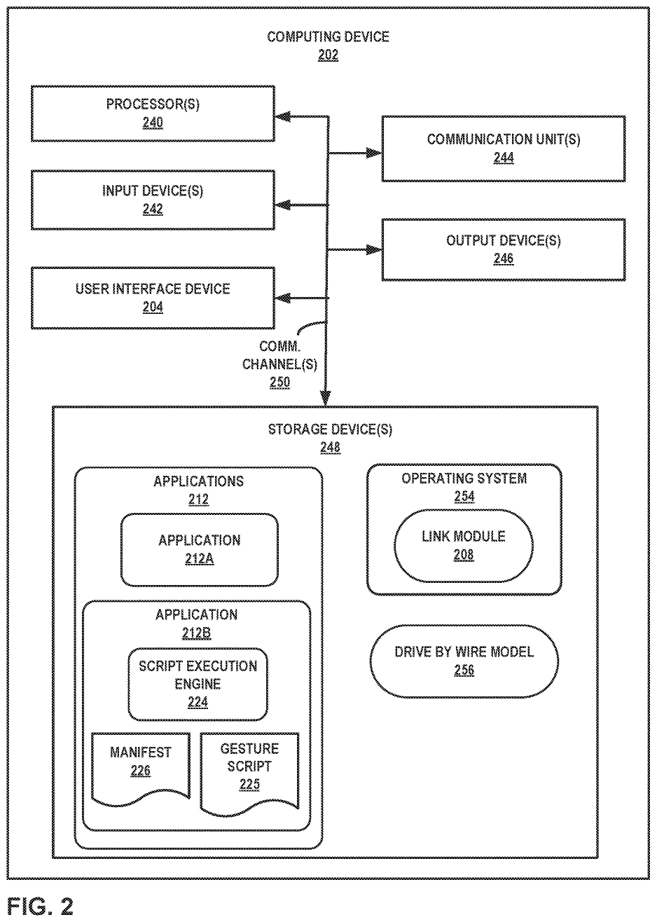

FIG. 2 is a block diagram illustrating an example computing device 202, in accordance with one or more aspects of the present disclosure. Computing device 202 of FIG. 2 is an example of computing device 102 of FIG. 1. Computing device 202 is only one particular example of computing device 102 of FIG. 1, and many other examples of computing device 102 may be used in other instances. In the example of FIG. 2, computing device 202 may be a mobile computing device (e.g., a smartphone), or any other computing device. Computing device 202 of FIG. 2 may include a subset of the components included in example computing device 202 or may include additional components not shown in FIG. 2.

As shown in the example of FIG. 2, computing device 202 includes user interface device 204 (“UID 204”), one or more processors 240, one or more input devices 242, one or more communication units 244, one or more output devices 246, and one or more storage devices 248. One or more storage devices 248 of computing device 202 also include operating system 254, link module 208, software applications 212, and drive by wire model 256.

Communication channels 250 may interconnect each of the components 240, 242, 244, 246, 248, and 204 for inter-component communications (physically, communicatively, and/or operatively). In some examples, communication channels 250 may include a system bus, a network connection, an inter-process communication data structure, or any other method for communicating data.

One or more input devices 242 of computing device 202 may be configured to receive input. Examples of input are tactile, audio, and video input. One or more input devices 242 of computing device 202, in one example, includes a presence-sensitive display, touch-sensitive screen, mouse, keyboard, voice responsive system, video camera, microphone or any other type of device for detecting input from a human or machine.

One or more output devices 246 of computing device 202 may be configured to generate output. Examples of output are tactile, audio, and video output. One or more output devices 246 of computing device 202, in one example, includes a presence-sensitive organic light emitting diode (OLED) display, sound card, video graphics adapter card, speaker, monitor, a presence-sensitive liquid crystal display (LCD), or any other type of device for generating output to a human or machine.

One or more communication units 244 of computing device 202 may be configured to communicate with external devices via one or more wired and/or wireless networks by transmitting and/or receiving network signals on the one or more networks.

Examples of one or more communication units 244 include a network interface card (e.g. such as an Ethernet card), an optical transceiver, a radio frequency transceiver, a GPS receiver, or any other type of device that can send and/or receive information. Other examples of one or more communication units 244 may include short wave radios, cellular data radios, wireless network radios, as well as universal serial bus (USB) controllers.

In some examples, UID 204 of computing device 202 may include functionality of one or more input devices 242 and/or one or more output devices 246. In the example of FIG. 2, UID 204 may be or may include a presence-sensitive input device. In some examples, a presence sensitive input device may detect an object at and/or near a screen. As one example range, a presence-sensitive input device may detect an object, such as a finger or stylus that is within 2 inches or less of the screen. The presence-sensitive input device may determine a location (e.g., an (x,y) coordinate) of a screen at which the object was detected. In another example range, a presence-sensitive input device may detect an object six inches or less from the screen and other ranges are also possible. The presence-sensitive input device may determine the location of the screen selected by a user's finger using capacitive, inductive, and/or optical recognition techniques. In some examples, a presence sensitive input device also provides output to a user using tactile, audio, or video stimuli as described with respect to one or more output devices 246, e.g., at a display. In the example of FIG. 2, UID 204 may present a user interface.

While illustrated as an internal component of computing device 202, UID 204 also represents an external component that shares a data path with computing device 202 for transmitting and/or receiving input and output. For instance, in one example, UID 204 represents a built-in component of computing device 202 located within and physically connected to the external packaging of computing device 202 (e.g., a screen on a mobile phone). In another example, UID 204 represents an external component of computing device 202 located outside and physically separated from the packaging of computing device 202 (e.g., a monitor, a projector, etc. that shares a wired and/or wireless data path with a tablet computer).

One or more storage devices 248 within computing device 202 may store information for processing during operation of computing device 202. In some examples, one or more storage devices 248 is a temporary memory, meaning that a primary purpose of one or more storage devices 248 is not long-term storage. One or more storage devices 248 on computing device 202 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

One or more storage devices 248, in some examples, also include one or more computer-readable storage media. One or more storage devices 248 may be configured to store larger amounts of information than volatile memory. One or more storage devices 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. One or more storage devices 248 may store program instructions and/or information (e.g., data) associated with operating system 254, link module 208, software applications 212, and drive by wire model 256.

One or more processors 240 may implement functionality and/or execute instructions within computing device 202. For example, one or more processors 240 on computing device 202 may receive and execute instructions stored by one or more storage devices 248 that execute the functionality of operating system 254, link module 208, software applications 212, and drive by wire model 256.

Operating system 254, link module 208, software applications 212, and drive by wire model 256 are described below executing at one or more processors 240. It should be understood that one or more processors 240 are configured to execute operating system 254, link module 208, software applications 212, and drive by wire model 256 to perform the functionality of operating system 254, link module 208, software applications 212, and drive by wire model 256 described below. That is, one or more processors 240 are configured to execute the instructions of operating system 254, link module 208, software applications 212, and drive by wire model 256 to perform the functionality of operating system 254, link module 208, software applications 212, and drive by wire model 256 described below.

Software applications 212 may include software applications 212A and 212B, which are examples of software applications 112A and 112B, respectively, of FIG. 1, and one or more processors 240 are configured to execute software applications 212A and 212B. For example, one or more processors 240 are configured to execute software application 212A to output a deep link to specific content in software application 212B. For example, software application 212A may be a web browser application, a messaging application, a social media application, or any other application that may generate a deep link to another software application of software applications 212.

Software application 212A may generate a deep link in response to a user input that selects a web link (i.e., a URL) displayed in the user interface of software application 212A. In the example where software application 212A is a web browser, software application 212A may present a web page that contains one or more web links to other web pages. If a user provides user input, such as a tap gesture, to select a web link contained in the web page, software application 212A may send an indication of the selected web link, such as an indication of the URL of the selected web link, to link module 208 as a deep link generated by software application 212A.

Operating system 254 may include link module 208, which is an example of link module 108 of FIG. 1. One or more processors 240 may be configured to receive an indication of a deep link from software application 212A, such as the indication of a web link selected at software application 212A, and to determine whether another software application of software applications 212 is able to handle the deep link. If link module 208 determinizes that another application of software applications 212, is able to handle the deep link, link module 208 may pass the deep link to the application that is able to handle the deep link.

In some examples, each of software applications 212 may specify the types of deep links to be performed that the respective application responds to. Each of software applications 212 may be associated with a manifest that lists the types of deep links to which the respective application responds. For example, software application 212B may include or be associated with manifest 226 that lists the types of deep links that software application 212B can handle. One or more processors 240 may therefore be configured to execute link module 208 to determine whether another application of software applications 212 based on the manifests of each of software applications 212. Each of software applications 212 may specify the types of deep links that can be handled by the respective application, such as by including, in their associated manifest an intent filter with paths and/or patterns of deep links handled by the software application. For example, a manifest of a software application may include an intent filter that specifies one or more domain names, which may indicate that the software application is able to handle deep links that are web links (e.g., hypertext transport protocol links) to web sites at those one or more domain names.

Software application 212B may be a software application that has been modified by an application publishing platform (e.g., computing system 120) to automatically handle deep links. An application publishing platform may modify software application 212B to handle deep links by creating or modifying manifest 226 of software application to include one or more intent filters that indicate deep links handled by software application 212B and by injecting script execution engine 224 into software application 212B to handle the deep links specified by manifest 226.

Script execution engine 224 is code that enables software application 212B to handle a deep link by programmatically interacting with the user interface of software application 212B to navigate to specific content in software application 212B indicated by deep links. Script execution engine 224 may enable software application 212B to programmatically interact with user interface controls (e.g., buttons, menus, etc.), enter text into text fields (e.g., search fields), navigate through screens of the software application, and/or otherwise interact with the user interface of software application 212B without user input in a similar fashion as a user that provides user input at an input device to interact with the user interface of software application 212B. Such interactions with the user interface of a software application are referred to herein as gestures.

Script execution engine 224 may also include code to retrieve or otherwise determine a sequence of interactions with the user interface of software application 212B that script execution engine 224 may perform to navigate to specific content in software application 212B indicated by deep links. That is, because script execution engine 224 may programmatically perform any pattern or sequence of interactions with the user interface of software application 212B, script execution engine 224 may receive and/or determine an indication of the specific sequence of interactions with the user interface of software application 212B that script execution engine 224 may perform in order to navigate software application 212B to the content specified by a deep link. Script execution engine 224 may therefore programmatically interact with the user interface of software application 212B according to the received and/or determined one or more interactions in order to navigate to or otherwise surface the content specified by the deep link.

Script execution engine 224 may not be designed for a specific software application to perform a specific set of interactions with the user interface of a software application in order to navigate to or surface the content specified by deep links handled by the software application. Rather, script execution engine 224 may be able to perform any sequence of programmatic interactions with the user interface of a software application, similar to how a user may provide user input to interact with the user interface of the software application. In order for script execution engine 224 to perform a sequence of interactions that is specific to software application 212B to navigate to or surface the content specified by deep links handled by software application 212B, script execution engine 224 include code to communicate with a computing system, such as computing system 120, to request and to receive from the computing system, gesture script 225 that is specific to software application 212B. Gesture script 225 may indicate one or more sequences of interactions with the user interface of software application 212B in order to perform one or more actions and/or navigate to specific content indicated by deep links handled by software application 212B.

A gesture script, such as gesture script 225, may be specific to a particular software application, such as being specific to software application 212B, and may specify a sequence of specific actions (e.g., gestures) to be performed by script execution engine 224 on specific views of the user interface of software application 212B. In some examples, gesture script 225 may identify views using corresponding view identifiers. Each specific action may include selection of a particular user interface element (e.g., a specific button or a specific text field), scrolling in a particular direction (e.g., up, down, left, or right) and/or for a particular distance (e.g., in terms of pixels), a swiping gesture, which may start and stop at specified locations in the screen, specific characters to enter via an on-screen virtual keyboard into a text field, and/or any other gesture that may be able to be performed by a user of the software application.

Script execution engine 224 may include code that exposes interfaces that provide details regarding the current screen of the user interface of the software application such as the view hierarchy, the accessibility tree, or a screenshot of the user interface. Script execution engine 224 may also include code that exposes interfaces that provide details of the views on the current screen of the user interface of the software application, such as resource identifiers, view identifiers, text in the views, and the like. Exposing such interfaces may enable script execution engine 224 to identify the views specified by a gesture script.

Script execution engine 224 may also include action actuators that expose interfaces that can perform certain interactions with the user interface of the software application, such as selecting, scrolling, or entering text, given view information or screen coordinates, and that can return statuses of whether certain actions were successfully performed. Such action actuators may thereby enable script execution engine 224 to perform the actions specified by gesture script 225 on corresponding views specified by the gesture script.

Manifest 226 of software application 212B may declare the type of deep links that software application 212B can handle. In particular, manifest 226 may declare deep links that are associated with script execution engine 224, so that script execution engine 224 may execute to handle a deep link by navigating to specific content in software application 212B indicated by the deep link.

In examples where deep links are in the form of a Uniform Resource Identifier (URI) or a Universal Resource Locator (URL), manifest 226 may declare one or more intent filters with paths and/or patterns of URIs and/or URLs handled by script execution engine 224 of software application 212B. For example, each intent filter may specify one or more domain names, such as “www.example.com” or “altostrat.com” to indicate that software application 212B is able to handle deep links that are web links to web sites at those one or more domain names. In another example, an intent filter may also specify one or more paths and/or patterns of paths, such as “/product” By specifying one or more paths and/or patterns of paths, manifest 226 may indicate that software application 212B is able to handle deep links that are web links to specific paths and/or patterns of paths at the specified domain names.

The following is an example intent filter in manifest 226 to declare deep links handled by software application 212B:

```
<activity android:name=”com.google.DeeplinkHandlerActivity”>
  <intent-filter android:autoVerify=”true”>
    <action android:name=”android.intent.action.VIEW” />
    <category android:name=”android.intent.category.DEFAULT” />
    <category android:name=”android.intent.category.BROWSABLE” />
    <data android:scheme=”http” />
    <data android:scheme=”https” >
    <data android:host=www.example.com” />
    <data android:pathPattern=”/products.*” />
  </intent-filter>>
</activity>
```

In this intent filter example, the intent filter may specify that software application 212B can handle both http and https links to the domain “www.example.com”. In this example, the intent filter also specifies a path of “/products.*” to specify that software application 212B may handle links to paths in the domain “www.example.com” that include the path “/products” as deep links, but that software application 212B may not handle links to paths in the domain “www.example.com” that does not include the path “/products” as deep links.

One or more processors 240 may be configured to receive an indication of a deep link from software application 212A and may be configured to execute link module 208 to determine, based on manifest 226, whether software application 212B is able to handle the deep link. Link module 208 may determine whether software application 212B is able to handle the deep link by determining whether the deep link matches the pattern of paths and/or patterns of URIs and/or URLs indicated by manifest 226.

For example, if the deep link is a URL that starts with “http://www.example.com/products”, link module 208 may determine that the deep link matches the intent filter of manifest 226 that indicates software application 212B as handing deep links that are http links to the domain name “www.example.com” and that specifies a path starting with “/products”. Link module 208 may therefore pass the deep link to software application 212B.

One or more processors 240 may be configured to, in response to link module 208 determining that application 212B is able to handle the deep link, execute software application 212B as the foreground application of computing device 202 to handle the deep link. For example, operating system 254 may launch software application 212B or may switch software application 212B to being a foreground application, such that the user interface of software application 212B is displayed by one or more output devices 246.

One or more processors 240 may be configured to, in response to link module 208 determining that application 212B is able to handle the deep link, execute link module 208 to send the deep link to software application 212B. For example, link module 208 may use any suitable message passing mechanism provided by operating system 254 to pass an indication of the deep link to software application 212B, such as by passing the URI or the URL of the deep link to software application 212B. One or more processors 240 may be configured to execute software application 212B to receive the deep link from link module 208 and to execute code, such as script execution engine 224, in software application 212B associated with handling of the deep link, to navigate to the content of software application 212B specified by the deep link. Script execution engine 224 may determine one or more interactions with the user interface of software application 212B to perform to navigate to the specific content of software application 212B specified by the deep link. In some examples, script execution engine 224 may send a request to an external system (e.g., computing system 120) via a network for gesture script 225 associated with software application 212B. Gesture script 225 associated with software application 212B may indicate the series of interactions that script execution engine 224 may perform at the user interface of software application 212B to perform to navigate to the specific content of software application 212B specified by the deep link. Such receipt of an indication of one or more interactions with the user interface may be referred to as gesture injection.

To send a request for gesture script 225 associated with software application 212B, script execution engine 224 may send a POST request that specifies the package name of software application 212B, a version code of software application 212B that indicates the version of software application 212B installed at computing device 202, and/or an indication of the feature associated with the gesture script, such as deep link automation. In response, software application 212B may receive gesture script 225 that indicates the series of interactions that script execution engine 224 may perform at the user interface of software application 212B to perform to navigate to the specific content of software application 212B specified by the deep link.

In some examples, gesture script 225 associated with software application 212B for automatically handling deep links may be located on a web site specified by the deep links. For example, web sites associated with software applications that contain script execution engine 224 may store a corresponding gesture script for the associated software application at a common location or path on the website, such as in the path “/gesturescripts”. Script execution engine 224 may therefore be able to communicate with the website associated with software application 212B to retrieve gesture script 225 for software application 212B at the common location of the website associated with software application 212B.

In some examples, instead of or in addition to sending a request to an external system for gesture script 225 associated with software application 212B, script execution engine 224 may send a request to operating system 254 for a gesture script associated with software application 212B. For example, operating system 254 may, when downloading software application 212B from an application publishing platform, also download one or more gesture scripts associated with software application 212B. Script execution engine 224 may, in response to sending the request for a gesture script associated with software application 212B, receive the requested gesture script from operating system 254.

One or more processors 240 may be configured to, in response to determining the one or more interactions with the user interface of software application 212B, execute the code added to software application 212B by an external computing system to perform the one or more interactions with the user interface of software application 212B. For example, one or more processors 240 may be configured to execute script execution engine 224 to perform the sequence of interactions with the user interface of software application 212B according to the received gesture script 225 to programmatically interact with the user interface of software application 212B to navigate to specific content of software application 212B specified by the deep link.

By programmatically interacting with the user interface of software application 212B, script execution engine 224 may perform a sequence of gestures to interact with the user interface of software application 212B without any user interactions with the user interface of software application 212B. For example, script execution engine 224 may be able to select and/or unselect buttons in the user interface of software application 212B, input text into text fields of the user interface of software application 212B, scroll through lists in the user interface of software application 212B, perform gestures such as swiping gestures at the user interface of software application 212B, provide voice input such as voice commands at the user interface of software application 212B, or perform any other interactions with the user interface of software application 212B.

The following is example pseudocode for script execution engine 224 to fetch a gesture script such as gesture script 225 and to perform the gestures specified by the gesture script:

```
@Override
public void onCreate(Bundle savedInstanceState) {
    super.on Create(savedInstanceState);
    // Step 1: Extract source URL from the intent
    Intent intent = getIntent( );
    String appLinkAction = intent.getAction( );
    Uri appLinkData = intent.getData( );
    if (Intent.ACTION_VIEW.equals(appLinkAction) && appLinkData != null) {
      try {
      // Step 2: Fetch a set of user gestures from Deeplinks service
      // which calls a backend API.
      List<UserGestures> appLinkGestures = deeplinkBackendService.fetchGestures(
          getPackageName( ), getAppVersionCode( ), appLinkData);
        // Step 3: Perform the returned set of gestures within the app
        // This is just an example of a single gesture
        startActivity(...);
        // Post action on the main/UI thread once the in-app Activity opens
        main ThreadHandler.post(new Runnable( ) {
          @Override
          public void run( ) {
          // Step 1: Find rootviews attached to the screen using
android.view.WindowManagerGlobal
          // Step 2: Capture the search element on screen, type the search term and enter.
          View editTextView = (EditText)
rootView.findViewById(appLinkGestures.get(0).getSearchBarResourceId( ));
            editTextView.setText(appLinkGestures.get(0).getSearchTerm( ));
            editTextView.onEditorAction(IME_ACTION_GO); // Simulate clicking
enter
    }
  });
      } catch(Exception e) {
      // Redirect user to browser or open link in web view
      }
    }
}
```

In the example pseudocode above, script execution engine 224 may fetch a gesture script from a computing system, such as computing system 120, that specifies a sequence of gestures to be performed at the user interface of software application 212B.

In some examples, gesture script 225 may also include logic for extracting, from a deep link, one or more search terms that script execution engine 224 may input into the search field. That is, gesture script 225 may include logic to extract, from any deep link supported by software application 212B, information that may be used as one or more search terms that software application 212B may programmatically enter into the search field of software applications 212 in order to navigate to specific content of software applications 212 indicated by the deep links.

In some examples, the logic in gesture script 225 may extract parameter values of one or more parameters in deep links handled by software application 212B as one or more search terms that are inputted into the search field. The logic in gesture script 225 may heuristically determine one or more parameters that may indicate or be associated with a product or item identifier and may extract the parameter values of those one or more parameters. For example, the logic in gesture script 225 may search a deep link for parameters that may include, in the parameter name, the word “item” or “product”, and may extract the parameter values of the identified one or more parameters as search terms to be inputted into the search field.

As can be seen, script execution engine 224 may handle a deep link by performing the sequence of gestures indicated by gesture script 225 to navigate from a root view (e.g., a home screen) of software application 212B to a search field of software application 212B. Script execution engine 224 engine may therefore perform gestures to reach the search field, use the logic in the gesture script to parse the deep link to extract one or more search terms from the deep link, input one or more search terms into the search field, and select an “enter” button to cause the search functionality of software application 212B to search for the inputted search term in software application 212B, thereby causing software application 212B to navigate to a screen of software application 212B associated with the deep link.

In some examples, instead of programmatically performing a sequence of gestures at the user interface of software application 212B according to gesture script 225, script execution engine 224 may communicate with drive by wire model 256 that may provide, to script execution engine 224, a sequence of interactions to perform with the user interface of software application 212B to.

Drive by wire model 256 may be a shared library or a shared service that is a trained by machine learning to determine, for any given software application, a sequence of interactions with the user interface of the software application to find a search field of the software application and to enter a search term into the search field. That is, drive by wire model 256 may not be trained specifically for a particular software application. Instead, drive by wire model 256 may be able to determine, for any software application, a sequence of interactions with the user interface of the software application to find a search field of the software application and to enter a search term into the search field.

Drive by wire model 256 may include one or more neural networks trained via imitation learning, in which drive by wire model 256 may learn by being demonstrated a task. Drive by wire model 256 may be trained to imitate navigating through screens of software applications to find the search field of the software applications. For example, gestures to interact with the user interfaces of a wide variety of software applications to reach the search field of each of the software applications may be demonstrated to drive by wire model 256, so that drive by wire model 256 may learn, based on the demonstrations, the gestures to perform to reach the search field of software applications that were not part of the demonstration.

The training data for drive by wire model 256 may include, for each of a plurality of applications being demonstrated, a sequence of gestures to be performed to interact with the user interface of the application to reach and input text into a search field of the application, a sequence of screen shots of the user interface of the application corresponding to performance of each of the gestures, a view hierarchy of the application, and the like. Thus, at each step, the training data may demonstrate, for a particular screen of the application, a gesture that is performed, the screen to which the application navigates as a result of the gesture, and so on, thereby enabling drive by wire model 256 to learn how to navigate different user interfaces of different applications to reach and enter text into the search field.

One or more processors 240 may be configured to execute script execution engine 224 may communicate with drive by wire model 256 to receive, from drive by wire model 256, indications of a sequence of gestures to perform at the user interface of software application 212B, starting from the home screen of software application 212B, to reach a search field and enter one or more search terms. Script execution engine 224 may, in response to software application 212B receiving a deep link to be handled, send an indication of the view hierarchy of software application 212B and a screenshot of the home screen of software application 212B to drive by wire model 256.

Drive by wire model 256 may receive the indication of the view hierarchy of software application 212B and the screenshot of the home screen of software application 212B and may output, to software application 212B an indication of a gesture to be performed at the home screen of software application 212B. The indication of the gesture may for example, indicate a specific type of gesture (e.g., a tap gesture, a swipe gesture, etc.), an indication of a user interface control at which the gesture is performed, one or more pixel locations at which the perform the gesture, and the like. In some examples, drive by wire model 256 may output an indication of a gesture in the form of a macro action, which may specify an element (e.g., a particular user interface control), an action (e.g., a type of gesture to perform at the user interface and/or at the specified element), and one or more arguments for the action (e.g., search terms to be inputted into a text field).

Script execution engine 224 may receive the indication of the gesture and may, in response, perform the gesture as indicated. Script execution engine 224 may take a screenshot of the resulting user interface (e.g., a resulting screen) of software application 212B and may send the screenshot and an indication of the location of the current screen to drive by wire model 256, and drive by wire model 256 may, in response, output, to software application 212B an indication of another gesture to be performed at the user interface of software application 212B. Script execution engine 224 may receive the indication of the gesture and may, in response, perform the gesture as indicated. Script execution engine 224 and drive by wire model 256 may repeat such a process until script execution engine 224 navigates software application 212B to reach and enter text into the search field.

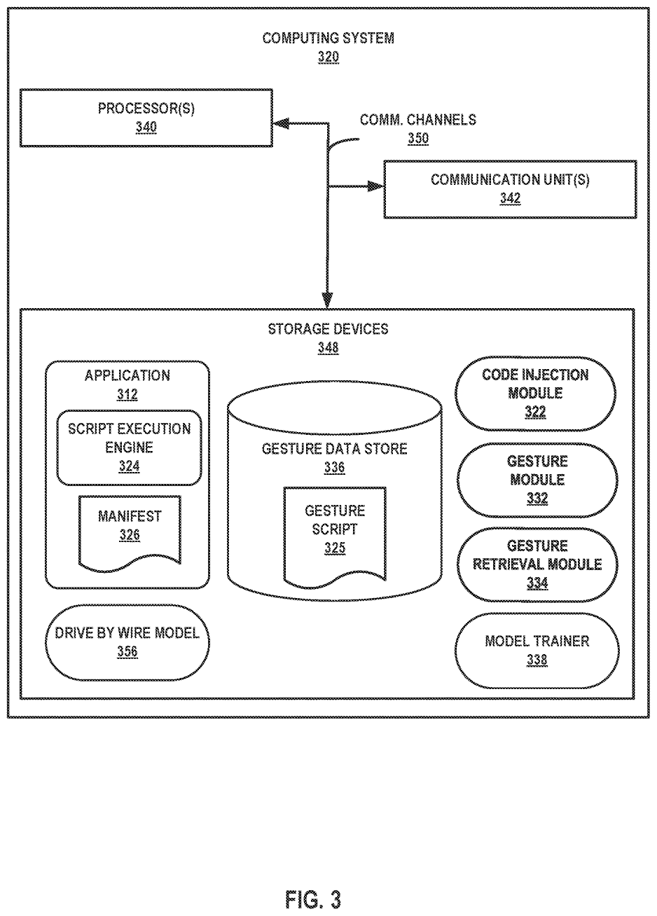

FIG. 3 is a block diagram illustrating an example computing system, in accordance with one or more aspects of the present disclosure. Computing system 320 of FIG. 3 is described below as an example of computing system 120 of FIG. 1. FIG. 3 illustrates only one particular example of computing system 320, and many other examples of computing system 320 may be used in other instances and may include a subset of the components included in example computing system 320 or may include additional components not shown in FIG. 3. For example, computing system 320 may comprise a cluster of servers, and each of the servers comprising the cluster of servers making up computing system 320 may include all, or some, of the components described herein in FIG. 3, to perform the techniques disclosed herein.

As shown in the example of FIG. 3, computing system 320 includes one or more processors 340, one or more communication units 342, and one or more storage devices 348. One or more storage devices 348 include software application 312, which is an example of software application 112B of FIG. 1 and software application 212B of FIG. 2, code injection module 322, which is an example of code injection module 122 of FIG. 1, gesture module 332, gesture retrieval module 334, model trainer 338, drive by wire model 356, which is an example of drive by wire model 256 of FIG. 1, and gesture data store 336.

One or more processors 340 may implement functionality and/or execute instructions associated with computing system 320. Examples of one or more processors 340 include application processors, display controllers, auxiliary processors, one or more sensor hubs, and any other hardware configured to function as a processor, a processing unit, or a processing device. Code injection module 322, gesture module 332, gesture retrieval module 334, and model trainer 338 may be operable by one or more processors 340 to perform various actions, operations, or functions of computing system 320. For example, one or more processors 340 of computing system 320 may retrieve and execute instructions stored by one or more storage devices 348 that cause one or more processors 340 to perform the operations of code injection module 322 gesture module 332, gesture retrieval module 334, and model trainer 338. The instructions, when executed by one or more processors 340, may cause computing system 320 to store information within one or more storage devices 348.

One or more communication units 342 of computing system 320 may communicate with external devices via one or more wired and/or wireless networks by transmitting and/or receiving network signals on the one or more networks. Examples of one or more communication units 342 include a network interface card (e.g., such as an Ethernet card), an optical transceiver, a radio frequency transceiver, a global positioning satellite (GPS) receiver, or any other type of device that can send and/or receive information. Other examples of one or more communication units 342 may include short wave radios, cellular data radios, wireless network radios, as well as universal serial bus (USB) controllers.

Communication channels 350 may interconnect each of the components 340, 342, and 348 for inter-component communications (physically, communicatively, and/or operatively). In some examples, communication channels 350 may include a system bus, a network connection, an inter-process communication data structure, or any other method for communicating data.

One or more storage devices 348 within computing system 320 may store information for processing during operation of computing system 320 (e.g., computing system 320 may store data accessed by code injection module 322 and gesture module 332 during execution at computing system 320). In some examples, one or more storage devices 348 is a temporary memory, meaning that a primary purpose of one or more storage devices 348 is not long-term storage. In this example, one or more storage devices 348 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

In some examples, one or more storage devices 348 may also include one or more computer-readable storage media. One or more storage devices 348, in some examples, include one or more non-transitory computer-readable storage mediums. One or more storage devices 348 may be configured to store larger amounts of information than typically stored by volatile memory. One or more storage devices 348 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. One or more storage devices 348 may store program instructions and/or information (e.g., data) associated with code injection module 322, gesture module 332, gesture retrieval module 334, model trainer 338, and gesture data store 336. One or more storage devices 348 may include a memory configured to store data or other information associated with code injection module 322, gesture module 332, gesture retrieval module 334, model trainer 338, and gesture data store 336.

A developer of a software application, such as software application 312, may upload their software application onto computing system 320 as part of the application publishing process to publish the software application to an application publishing platform, such as an app store. The developer may, as part of the application publishing process, opt into allowing computing system 320 to automatically modify the software application to add support for handling deep links prior to publishing the software application.

If the developer of software application 312 opts into allowing computing system 320 to automatically modify software application 312 to add support for handling deep links, one or more processors 340 may be configured to execute code injection module 322 to modify software application 312 by performing code injection to add code, such as executable code, object code, and the like to software application 312 that can execute to perform one or more actions to handle deep links to specific content in software application 312. For example, code injection module 322 may disassemble the package of software application 312 into one or more executable files, perform the code injection to add code to the one or more executable files, assemble the executable files that have been injected with code back into a package, and to sign the package of software application 312 using a cryptographic key associated with the developer of software application 312. The signed package of software application 312 may therefore be ready to be published onto an application publishing platform for download by computing devices.

One or more processors 340 may be configured to execute code injection module 322 to inject script execution engine 324 to software application 312. Script execution engine 324 is code that enables software application 312 to handle a deep link by programmatically interacting with the user interface of software application 312 to navigate to specific content in software application 312 indicated by deep links. Script execution engine 324 may enable software application 312 to programmatically interact with user interface controls (e.g., buttons, menus, etc.), enter text into text fields (e.g., search fields), navigate through screens of the software application, and/or otherwise interact with the user interface of software application 312 without user input in a similar fashion as a user that provides user input at an input device to interact with the user interface of software application 312. Such interactions with the user interface of a software application are referred to herein as gestures.

Script execution engine 324 may also include code to retrieve or otherwise determine a sequence of interactions with the user interface of software application 312 that script execution engine 324 may perform to navigate to specific content in software application 312 indicated by deep links. That is, because script execution engine 324 may programmatically perform any pattern or sequence of interactions with the user interface of software application 312, script execution engine 324 may receive and/or determine an indication of the specific sequence of interactions with the user interface of software application 312 that script execution engine 324 may perform in order to navigate software application 312 to the content specified by a deep link. Script execution engine 324 may therefore programmatically interact with the user interface of software application 312 according to the received and/or determined one or more interactions in order to navigate to or otherwise surface the content specified by the deep link.

In some examples, script execution engine 324 include code to communicate with a computing system, such as computing system 320 to request and to receive from the computing system, a gesture script that indicates one or more sequences of interactions with the user interface of software application 312 in order to perform one or more actions and/or navigate to specific content indicated by deep links.

A gesture script may be specific to a particular software application, such as being specific to software application 312, and may specify a sequence of specific actions (e.g., gestures) to be performed by script execution engine 324 on specific views of the user interface of software application 312. In some examples, the gesture script may identify views using corresponding view identifiers. Each specific action may include selection of a particular user interface element, scrolling in a particular direction (e.g., up, down, left, or right) and/or for a particular distance (e.g., in terms of pixels), a swiping gesture, which may start and stop at specified locations in the screen, and/or any other gesture that may be able to be performed by a user of the software application.

Script execution engine 324 may include code that exposes interfaces that provide details regarding the current screen of the user interface of the software application such as the view hierarchy, the accessibility tree, or a screenshot of the user interface. Script execution engine 324 may also include code that exposes interfaces that provide details of the views on the current screen of the user interface of the software application, such as resource identifiers, view identifiers, text in the views, and the like. Exposing such interfaces may enable script execution engine 324 to identify the views specified by a gesture script.

Script execution engine 324 may also include action actuators that expose interfaces that can perform certain interactions with the user interface of the software application, such as selecting, scrolling, or entering text, given view information or screen coordinates, and that can return statuses of whether certain actions were successfully performed. Such action actuators may thereby enable script execution engine 324 to perform the actions specified by a gesture script on corresponding views specified by the gesture script.

The following is example pseudocode for script execution engine 324 to fetch a gesture script and to perform the gestures specified by the gesture script:

```
@Override
public void onCreate(Bundle savedInstance State) {
    super.onCreate(savedInstanceState);
    // Step 1: Extract source URL from the intent
    Intent intent = getIntent( );
    String appLinkAction = intent.getAction( );
    Uri appLinkData = intent.getData( );
    if (Intent.ACTION_VIEW.equals(appLinkAction) && appLinkData != null) {
      try {
        // Step 2: Fetch a set of user gestures from Deeplinks service
        // which calls a backend API.
        List<UserGestures> appLinkGestures = deeplinkBackendService.fetch Gestures(
          getPackageName( ), getAppVersionCode( ) , appLinkData);
        // Step 3: Perform the returned set of gestures within the app
        // This is just an example of a single gesture
        startActivity(...);
        // Post action on the main/UI thread once the in-app Activity opens
        main ThreadHandler.post(new Runnable( ) {
          @Override
          public void run( ) {
          // Step 1: Find rootviews attached to the screen using
android.view.WindowManagerGlobal
          // Step 2: Capture the search element on screen, type the search term and enter.
          View editTextView = (EditText)
rootView.findViewById(appLinkGestures.get(0).getSearchBarResourceId( );
            editTextView.setText(appLinkGestures.get(0).getSearch Term( ));
            editTextView.onEditorAction(IME_ACTION_GO); // Simulate clicking
enter
    }
  });
        } catch(Exception e) {
        // Redirect user to browser or open link in web view
        }
    }
}
```

One or more processors 340 may be configured to execute code injection module 322 to also modify software application 312 by modifying and/or creating manifest 326 of software application 312, to declare the type of deep links that software application 312 can handle. In some examples, as part of the publishing process of software application 312, the developer of software application 312 may upload manifest 326 along with software application 312, and code injection module 322 may modify manifest 326 to declare the type of deep links that software application 312 can handle.

One or more processors 340 may be configured to execute code injection module 322 to generate and/or modify manifest 326 of software application 312 to declare the deep links handled by software application 312 and to associate the declared deep links with script execution engine 324. By declaring the associated deep links with script execution engine 324, script execution engine 324 may therefore execute to handle a deep link by navigating to specific content indicated by the deep link.

In examples where deep links are in the form of a Uniform Resource Identifier (URI) or a Universal Resource Locator (URL), one or more processors 340 may be configured to execute code injection module 322 to add, to manifest 326 of software application 312, one or more intent filters with paths and/or patterns of URIs and/or URLs handled by software application 312. For example, code injection module 322 may specify, in the manifest of software application 312, one or more domain names, such as “www.example.com” or “altostrat.com” to indicate that software application 312 is able to handle deep links that are web links to web sites at those one or more domain names. In another example, code injection module 322 may specify, in the manifest of the software application, one or more paths and/or patterns of paths, such as “/product”. By specifying one or more paths and/or patterns of paths, manifest 326 may indicate that software application 312 is able to handle deep links that are web links to specific paths and/or patterns of paths at the specified domain names.

The following is an example intent filter that code injection module 322 may add to manifest 326 to declare deep links handled by software application 312:

```
<activity android:name=”com.google.DeeplinkHandlerActivity”>
  <intent-filter android:autoVerify=”true”>
    <action android:name=”android.intent.action.VIEW” />
    <category android:name=”android.intent.category.DEFAULT” />
    <category android:name=”android.intent.category.BROWSABLE” />
    <data android:scheme=”http” />
    <data android:scheme=”https” />
    <data android:host=”www.example.com” />
    <data android:pathPattern=”/products.*” />
  </intent-filter>
</activity>
```

In this intent filter example, the intent filter may specify that software application 312 can handle both http and https links to the domain “www.example.com”. In this example, the intent filter also specifies a path of “/products.*” to specify that software application 312 may handle links to paths in the domain “www.example.com” that include the path “/products” as deep links, and that software application 312 may not handle links to paths in the domain “www.example.com” that does not include the path “/products” as deep links.

Code injection module 322 may utilize a variety of different techniques to determine how to form an intent filter in manifest 326 to declare the deep links handled by software application 312. In some examples, a developer of software application 312 may provide or register with computing system 320 domain names owned and/or associated with the developer as part of registering with an application distribution platform in order to distribute software application 312 using the application distribution platform. Code injection module 322 may therefore add, to manifest 326, one or more intent filters that specify one or more of the domain names that are owned and/or associated with the developer as URLs handled by the software application 312.

In some examples, code injection module 322 may crawl websites at the one or more domain names to determine paths and/or path patterns of the one or more domain names that software application 312 may be able to handle as deep links. Code injection module 322 may crawl the websites to infer path patterns that can be handled as deep links to specific content in software application 312. In the example where software application 312 is a shopping application, code injection module 322 may infer path patterns for links to items that are for sale. For example, given a domain name of “www.example.com”, code injection module 322 may infer that links to products for sale all follow the pattern of having a path of “www.example.com/products/sale”. Code injection module 322 may therefore add an intent filter in manifest 326 that specifies the domain name of “www.example.com” and a path pattern of “/products/sale*” to specify that software application 312 may interpret web links that start off with “www.example.com/products/sale” as a deep link to specific content within software application 312.

In some examples, code injection module 322 may use advertisement data associated with websites at the one or more domain names to determine paths and/or path patterns of the one or more domain names that software application 312 may be able to handle as deep links. For example, if software application 312 is a shopping application, and if an advertiser associated with software application 312 advertises one or more products at a search engine that is associated with computing system 320, code injection module 322 may analyze the web links to the products being advertised to infer path patterns of web links to products that are for sale. For example, given a domain name of “altostrat.com”, code injection module 322 may infer that links to products for sale all follow the pattern of having a path of “altostrat.com/items/”. Code injection module 322 may therefore add an intent filter in manifest 326 that specifies the domain name of “altostrat.com” and a path pattern of “/items *” to specify that software application 312 may interpret web links that start off with “www.altostrat.com/items” as a deep link to specific content within software application 312.

In some examples, code injection module 322 may receive, from a developer of software application 312, information that code injection module 322 may use to generate intent filters added to the manifest of software application 312. For example, the developer may provide domain names, paths, path patterns, and the like, and code injection module 322 may add intent filters into manifest 326 to declare deep links that handles the specified domain names, paths, and/or path patterns.

In some examples, one or more processors 340 may be configured to execute gesture module 332 to determine, for a software application, such as software application 312, that is modified by computing system 320 to handle a deep link, a sequence of one or more interactions with the user interface of the software application to perform the action to navigate to the deep linked specific content of the software application. Gesture module 332 may save the determined sequence of one or more interactions into gesture script 325, which is an example of gesture script 225 of FIG. 2. When the software application is later executed, the software application may perform the one or more interactions determined by gesture module 332 and indicated in gesture script 325 to handle a deep link and to navigate to specific content indicated by the deep link.

In some examples, one or more processors 340 may be configured to execute gesture module 332 to receive, from the developer of software application 312, an indication of the one or more interactions with the user interface of software application 312 to handle a deep link and to navigate to specific content indicated by the deep link. That is, the developer of software application 312 may be able to specify the interactions with the user interface that is to be performed in order to navigate to specific content indicated by a deep link. For example, computing system 320 may provide a user interface console that enables the developer to interact with the user interface of software application 312 to navigate to specific content indicated by one or more deep links. Gesture module 332 may record the series of interactions with software application 312 to navigate to specific content indicated by one or more deep links and may generate gesture script 325 that indicates the series of interactions with software application 312.

In some examples, one or more processors 340 may be configured to execute gesture module 332 to crawl the user interface of software application 312 in order to identify user interface elements of the user interface and actions that can be performed by interacting with the user interface elements of the user interface. The user interface of software application 312 may include or be associated with a view hierarchy, which is a tree-like structure that defines relationships between views in the user interface and that is used to determine the layout and rendering of software application 312's user interface. Such views in the view hierarchy may include user interface elements (e.g., buttons, text fields, etc.) and layout containers.

Gesture module 332 may crawl the view hierarchy of the user interface of software application 312 to capture identifiers for different activities and elements (e.g., views) encountered in the screens of the user interface. Such identifiers and elements may include information such as view identifiers, resource identifiers, layouts, the properties of the views in the view hierarchy, text labels of the views, and the like.

Gesture module 332 may use the information captured while crawling the view hierarchy, such as view identifiers, resource identifiers, text labels of input fields, and the like to tag the elements encountered while crawling the view hierarchy. For example, gesture module 332 may encounter an input field having a text label that includes the word “search” and may therefore tag the input field as a search field for the software application. In another example, gesture module 332 may encounter a screen of the user interface that is at the root of the view hierarchy and may tag the screen as the home screen of software application 312. In another example, gesture module 332 may encounter a set of input fields having text labels such as “origin,” “destination,” “arrival date,” “departure date,” and the like, and may, based on the text labels, tag the input fields as travel fields.

Gesture module 332 may also capture the gestures to be performed, such as selecting one or more elements, scrolling through one or more screens, and the like to traverse the screens of the user interface to navigate through the user interface to reach various elements of the user interface. For example, if a first screen of the user interface links to a second screen via a button at the bottom of the first screen, gesture module 332 may capture a scrolling gesture to scroll the first screen down to the button at the bottom of the first screen and a selection gesture to select the button that links to the second screen of the user interface. In this way, gesture module 332 may be able to capture or otherwise determine gestures to be performed on the user interface of software application 312 to navigate between screens of the user interface and to navigate between different mapped elements of the user interface.

One or more processors 340 may be configured to execute gesture module 332 to determine, based on crawling the user interface of software applications 312, sequences of interactions with the user interface of software application 312 in order to perform one or more actions and/or navigate to specific content indicated by deep links. For example, one or more processors 340 may be configured to execute gesture module 332 to crawl the user interface of software application 312 to derive the shortest path (i.e., least number of interactions) from a home screen of the user interface of software application 312 to enter one or more search terms into a search field of the user interface of software application 312.

The search field of a software application may be located in different places (e.g., in different views and/or screens) depending on the software application. In some examples, the search field may be placed in the home screen, in the navigation drawer, or in a dedicated search page. If the home screen and the search field of the software application are already tagged, gesture module 332 may use the information captured while crawling the view hierarchy to determine the shortest path, starting from the view tagged as the home screen, to reach an input field that is tagged as the search field in the software application.

One or more processors 340 may therefore be configured to execute gesture module 332 to generate gesture script 325 that indicates one or more sequences of interactions with the user interface of software application 312 in order to perform one or more actions and/or navigate to specific content indicated by deep links. For example, gesture script 325 may indicate a sequence of gestures to be performed at the user interface of software application 312 to navigate from the home screen to the search field. Because gesture module 332 has crawled software application 312 to identify the locations of the home screen and the search field of software application 312 within the view hierarchy, gesture module 332 may be able to generate the sequence of gestures to be performed at the user interface of software application 312 to navigate from the home screen to the search field.

A gesture script may be specific to a particular software application and may specify a sequence of specific actions (e.g., gestures) to be performed on specific views, where views may be identified using corresponding view identifiers. For example, each specific action may include selection of a particular user interface element, scrolling in a particular direction (e.g., up, down, left, or right) and/or for a particular distance (e.g., in terms of pixels), a swiping gesture, which may start and stop at specified locations in the screen, and/or any other gesture that may be able to be performed by a user of the software application.

In examples where gesture module 332 generates gesture script 325 to navigate to a text input field, such as a search field, one or more processors 340 may be configured to execute gesture module 332 to generate logic for extracting data from deep links handled by software application 312 and inputting the extracted data into the text input field to navigate to specific content indicated by one or more deep links. For example, if gesture script 225 simulates the processes of searching for a product or an item in the search field of software application 312, gesture module 332 may be able to generate logic for parsing a deep link to extract one or more search terms that are to be inputted into the search bar to navigate to the product or item in software application 312. Gesture module 332 may therefore include such logic in gesture script 325.

In examples where gesture script 325 specifies a sequence of gestures to navigate to a search field to search for one or more items or products linked to by a deep link, gesture module 332 may generate logic in gesture script 325 to extract parameter values of one or more parameters in a deep link handled by software application 312 as one or more search terms that are inputted into the search field to navigate to the product or item in software application 312 specified by the deep link. In some examples, gesture module 332 may include logic in gesture script 325 to heuristically determine one or more parameters that may indicate or be associated with a product or item identifier and to extract the parameter values of those one or more parameters. For example, the logic in gesture script 325 may search for parameters that may include, in the parameter name, the word “item” or “product”, and may extract the parameter values of the identified one or more parameters.

The logic in gesture script 325 may also include one or more gestures to input the extracted parameter value into the search field and to search for the inputted text. For example, given a deep link that contains “productid=123ABC”, the logic in gesture script 325 may be able to extract the parameter value of “123ABC” from the parameter “productid” and may include gestures to input the extracted parameter value of “123ABC” into the search field.

In some examples, gesture module 332 may, for each deep link of a plurality of deep links that is handled by software application 312, determine a screen of software application 312 that is most similar to the content of the web page linked to by the deep link. To determine similarities between screens of software application 312 and content of web pages, gesture module 332 may crawl the user interface of software application 312 to different screens of software application 312 and may generate hashes of screenshots of screens of software application 312 and screenshots of content of web pages to compare the generated hashes to determine similarities between screens of software application 312 and content of web pages.

Gesture module 332 may for each deep link of the plurality of deep links and the corresponding screen of software application 312 determined to be most similar to the contents of the web page linked by the deep link, determine one or more search terms extracted from the URL of the deep link to be inputted into the search field of software application 312 that would result in the search functionality of software application 312 navigating to the corresponding screen of software application 312. For example, gesture module 332 may attempt to extract and input different portions of the URL of the deep link as one or more search terms inputted into the search field to determine the portion of the URL that, when inputted as one or more search terms in the search field, would result in the search functionality of software application 312 navigating to the corresponding screen of software application 312.

Gesture module 332 may, based on the portions of the URLs of each of the plurality of deep links that, when inputted as one or more search terms in the search field, results in the search functionality of software application 312 navigating to a corresponding screen of software application 312, heuristically determine a pattern of the portion of the URL that is extracted as the one or more search terms for each of the deep links, and may generate logic for extracting the determined portion of the URL as the one or more search terms. Gesture module 332 may therefore add, to gesture script 225, the logic for extracting the determined portion of the URL as the one or more search terms.

For example, gesture module 332 may determine that the URL of each of the plurality of deep links follow a format of “http://www.example.com/en-US/products/<item identifier>/view”. Gesture module 332 may therefore generate logic for extracting the text between “products/” and “/view” in the URL as an item identifier that may be inputted into the search field that would result in the search functionality of software application 312 navigating to a screen of software application 312 associated with the deep linked item.

In some examples, one or more processors 340 are configured to train drive by wire model 356 that may be used by software applications, such as software application 312, to determine a sequence of interactions with a user interface of the software application to handle deep links. Drive by wire model 356 may be a shared library or a shared service and one or more processors 340 may execute model trainer 338 to train drive by wire model 356 using machine learning to determine, for any given software application, a sequence of interactions with the user interface of the software application to find a search field of the software application and to enter a search term into the search field. That is, model trainer 338 may not specifically train drive by wire model 356 for a particular software application. Instead, model trainer 338 may train drive by wire model 356 to be able to determine, for any software application, a sequence of interactions with the user interface of the software application to find a search field of the software application and to enter a search term into the search field.

Model trainer 338 may train drive by wire model 356 via imitation learning, in which drive by wire model 356 may learn by being demonstrated a task. Model trainer 338 may train drive by wire model 356 to imitate navigating through screens of software applications to find the search field of the software applications. For example, model trainer 338 may demonstrate, to drive by wire model 356, gestures to interact with the user interfaces of a wide variety of software applications to reach the search field of each of the software applications, so that drive by wire model 356 may learn, based on the demonstrations, the gestures to perform to reach the search field of software applications that were not part of the demonstration.

The training data for training drive by wire model 356 may include, for each of a plurality of applications being demonstrated, a sequence of gestures to be performed to interact with the user interface of the application to reach and input text into a search field of the application, a sequence of screenshots of the user interface of the application corresponding to performance of each of the gestures, a view hierarchy of the application, and the like. Thus, at each step, the training data may demonstrate, for a particular screen of the application, a gesture that is performed, the screen to which the application navigates as a result of the gesture, and so on, thereby enabling drive by wire model 356 to learn how to navigate different user interfaces of different applications to reach and enter text into the search field. As drive by wire model 356 is being trained, drive by wire model 356 may be able to recognize and learn the user interface elements that are included in each of the screenshots, thereby building a model of understanding of user interfaces of software applications to be able to output sequences of gestures to be performed to interact with the user interfaces of the applications. Once model trainer 338 has finished training drive by wire model 356, one or more processors 340 may make model trainer 338 available at an application publishing platform for download by computing devices, such as by computing devices that download software applications that have been modified by computing system 320 to support deep links.

One or more processors 340 may be configured to execute script execution engine 324 may communicate with drive by wire model 356 to receive, from drive by wire model 356, indications of a sequence of gestures to perform at the user interface of software application 312, starting from the home screen of software application 312, to reach a search field and enter one or more search terms. Script execution engine 324 may, in response to software application 312 receiving a deep link to be handled, send an indication of the view hierarchy of software application 312 and a screenshot of the home screen of software application 312 to drive by wire model 356.

In some examples, gesture module 332 may use drive by wire model 356 to generate gesture script 325 for software application 312. For example, gesture module 332 may send, to drive by wire model 356, information related to the user interface of software application 312, such as a view hierarchy, screenshots of different screens of software application 312, indications of the locations of the screenshots of the different screens in the view hierarchy, and the like. In response, drive by wire model 356 may be able to output a sequence of gestures that script execution engine 324 may perform to interact with the user interface of software application 312 to reach and input text into a search field of the software application 312.

Once gesture module 332 has generated gesture script 325, one or more processors 340 are configured to execute gesture module 332 to store gesture script 325 in gesture data store 336. Gesture data store 336 may be any suitable data store, such as one or more databases, object storage, one or more file systems, and the like. Gesture module 332 may associate, in gesture data store 336, each gesture script generated by gesture module 332 with the specific software application (e.g., software application 312) for which the gesture script was generated and/or a specific version of the software application. In some examples, gesture module 332 may associate each gesture script with a software application by associating each gesture script with the package name of the software application and/or a version code indicative of the version of the software application associated with the gesture script.

In some examples, gesture data store 336 may store a variety of gesture scripts that may be used for different features besides automation of deep links. Thus, gesture module 332 may also associate gesture scripts generated for deep link automation with the deep link automation feature.

One or more processors 340 may execute gesture retrieval module 334 to receive, from a software application at a computing device, a request for a gesture script and to, in response, retrieve the requested gesture script from gesture data store 336 and send the retrieved gesture script to the software application. In some examples, the request may indicate the software application associated with the requested gesture script, such as the package name of the software application. In examples where gesture scripts are associated with specific versions of a software application, the request may also indicate the version code of the software application. In examples where gesture scripts for different features are stored in gesture data store 336, the request may also indicate the feature, such as deep link automation, associated with the requested gesture script.

The following is an example POST request for a gesture script that gesture retrieval module 334 may receive from a software application:

```
/POST
{
  package_name,
  version_code,
  feature_enum
{
```

In the above example, the package_name may indicate the package name of the requesting software application and the version_code may indicate the version code of the requesting software application. The feature_enum may be an enumerator, such as DEEPLINK_AUTOMATION, that specifies the feature associated with the requested gesture script.

Gesture retrieval module 334 may retrieve the requested gesture script from gesture data store 336. For example, gesture retrieval module 334 may retrieve the gesture script associated with the package name, version code, and/or feature indicated by the request. Gesture retrieval module 334 may therefore send, via one or more communication units 342, the retrieved gesture script to the requesting software application at the requesting computing device.

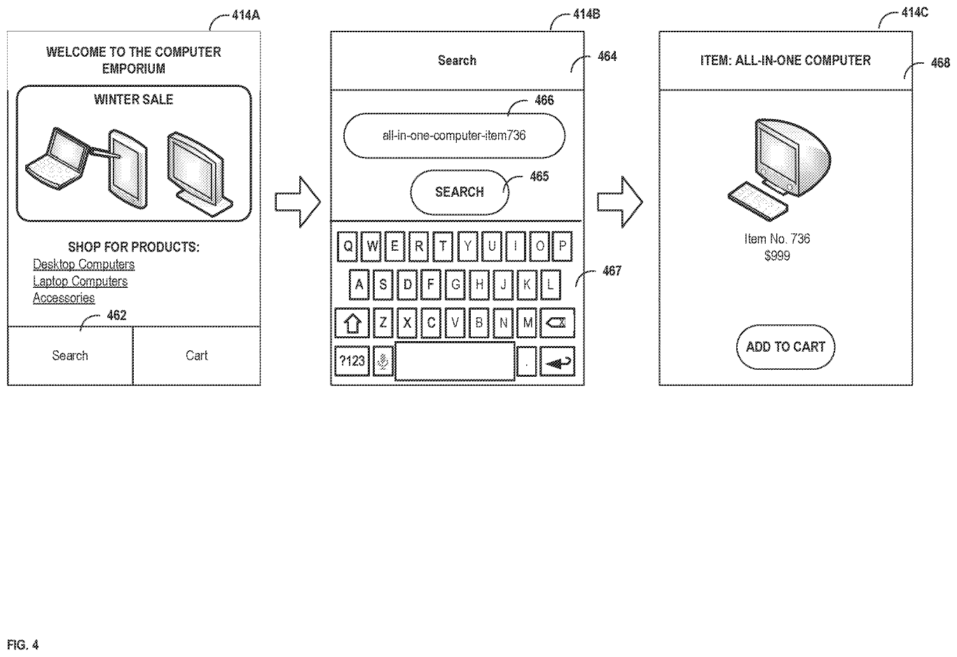

FIG. 4 is a conceptual diagram illustrating a software application interacting with an example user interface of the software application to handle a deep link, in accordance with aspects of the present disclosure. For purposes of illustration only, the example operations are described below within the context of application 212B executing at computing device 202 of FIG. 2.

Link module 208 of computing device 202 may receive an indication of a web link, such as “http://example.com/store/items/all-in-one-computer-item 736/view”, from software application 212A and may, in response, determine whether the web link is a deep link that can be handled by another software application. For example, link module 208 may determine, based on an intent filter in manifest 226 of software application 212B indicating that software application 212B handles deep links to the domain name “example.com” and to the path “/store*” that the web link “http://example.com/store/items/all-in-one-computer-item 736/view” is a deep link to specific content in software application 212B. Link module 208 may therefore send an indication of the deep link to software application 212B. Operating system 254 may also set software application 212B as the foreground application of computing device 202, such as by opening software application 212B or by switching to software application 212B as the foreground application of computing device 202.

As shown in FIG. 4, when software application 212B is the foreground application of computing device 202, user interface device 204 of computing device 202, such as a display device, may display the user interface of software application 212B, such as user interface 414A, which is the home screen of software application 212B. In the example of FIG. 4, software application 212B may be a shopping application for a retailer “Computer Emporium” that sells computers and related accessories that may also be associated with the web site “example.com”.

Software application 212B may receive an indication of the deep link from link module 208 and may determine one or more interactions with the user interface of software application 212B to navigate to specific content of software application 212B specified by the deep link. In some examples, software application 212B may retrieve gesture script 225 associated with software application 212B that may specify a sequence of interactions with the user interface of software application 212B to navigate to specific content of software application 212B. For example, software application 212B may communicate with an external computing system, such as computing system 120 of FIG. 1, to retrieve gesture script 225 associated with software application 212B.

Software application 212B may, in response to retrieving gesture script 225, programmatically interact with the user interface of software application 212B according to gesture script 225 to navigate to specific content of software application 212B. In the example of FIG. 4, the gesture script may specify a series of interactions with the user interface of software application 212B to navigate to a search field of software application 212B to enter an item number specified by the deep link to navigate to a screen of software application 212B that is a product page for an item associated with the item number.

For example, the sequence of gestures specified by gesture script 225 includes a gesture to select search button 462 in user interface 414A that is the home screen of software application 212B. Software application 212B may programmatically perform the specified gesture to select search button 462, such as by programmatically performing a tap gesture at search button 462. In response to selection of search button 462, software application 212B may transition from outputting user interface 414A to outputting user interface 414B, which may be search screen 464 of software application 212B that includes search field 466, for display at user interface device 204.

The next gesture in the sequence of gestures specified by gesture script 225 may include a gesture to select search field 466, to input a search term into search field 466, and to select search button 465 to cause software application 212B to search for the search term inputted into search field 466. Software application 212B may programmatically perform the specified gesture to select search field 466, such as by programmatically performing a tap gesture at search field 466. Selecting search field 466 may also cause user interface device 204 to display virtual keyboard 467.

Gesture script 225 may include logic for extracting one or more search terms from the deep link and to input the extracted one or more search terms into search field 466. For example, gesture script 225 may include logic to extract, as the search term, the text in the deep link between “items/” and “/view”. Thus, in the example where the deep link is “http://example.com/store/items/all-in-one-computer-item736/view”, software application 212B may apply the logic to the deep link to extract the text “all-in-one-computer-item 736” as the search term and may programmatically perform one or more interactions with virtual keyboard 467 to type, using virtual keyboard 467, the search term “all-in-one-computer” into search field 466. Software application 212B may therefore also programmatically perform the gesture specified by gesture script 225 to select search button 465, such as by programmatically performing a tap gesture at search button 465, to cause software application 212B to search for the search term “all-in-one-computer”.

Software application 212B may therefore search for a screen in software application 212B that includes or is associated with the search term “all-in-one-computer” and may, in response, find product page 468 that includes or is associated with the search term “all-in-one-computer”. Software application 212B may therefore transition from outputting user interface 414B to outputting user interface 414C, which may be product page 468 for an all-in-one computer in software application 212B. In this way, software application 212B may be able to navigate the user interfaces of software application 212B to handle a deep link to specific content in software application 212B.

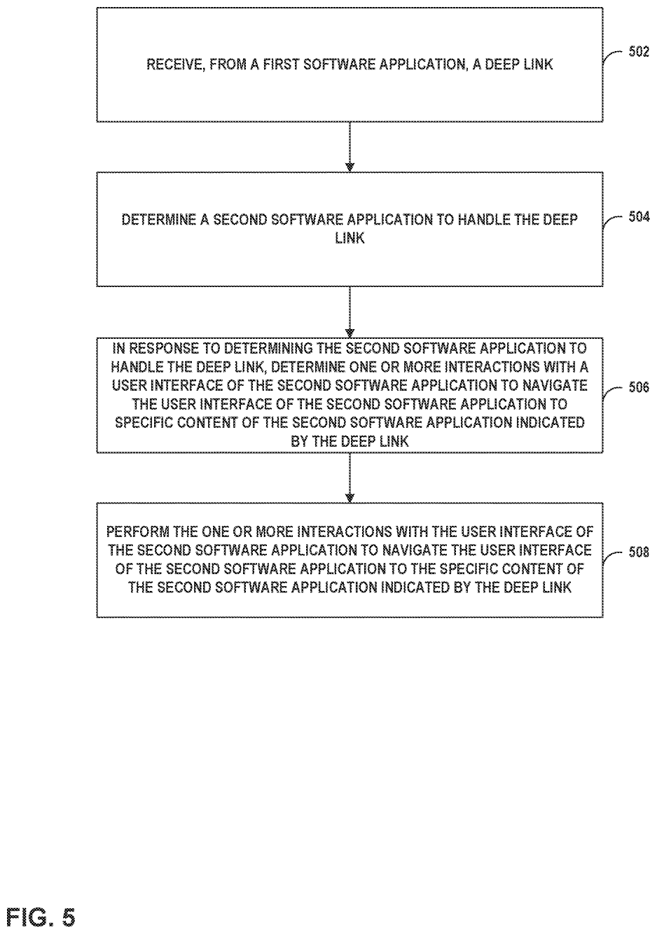

FIG. 5 is a flowchart illustrating example operations of an example computing device, in accordance with one or more aspects of the present disclosure. For purposes of illustration only, the example operations are described below within the context of computing device 202 of FIG. 2.

As shown in FIG. 5, one or more processors 240 of computing device 202 may receive, from a first software application 212A, a deep link (502). One or more processors 240 may determine a second software application 212B to handle the deep link (504). One or more processors 240 may, in response to determining the second software application 212B to handle the deep link, determine one or more interactions with a user interface of the second software application 212B to navigate the user interface of the second software application 212B to specific content of the second software application 212B indicated by the deep link (506). One or more processors 240 may perform, without user intervention, the one or more interactions with the user interface of the second software application 212B to navigate the user interface of the second software application 212B to the specific content of the second software application 212B indicated by the deep link (508).

In some examples, to determine the one or more interactions with the user interface of the second software application 212B to navigate the user interface of the second software application 212B to the specific content of the second software application 212B, one or more processors 240 may execute the second software application 212B to receive, from a computing system, an indication of the one or more interactions with the user interface. In some examples, the one or more interactions with the user interface of the second software application 212B includes one or more gestures to be performed at the user interface of the second software application 212B.

In some examples, to determine the one or more interactions with the user interface of the second software application 212B to navigate the user interface of the second software application 212B to the specific content of the second software application 212B, one or more processors 240 may execute the second software application to retrieve, from a computing system 120, an indication of a sequence of interactions with the user interface.

In some examples, to retrieve the indication of the sequence of interactions with the user interface, one or more processors 240 may execute code added by an external computing system to the second software application 212B to retrieve, from the computing system 120, the indication of the sequence of interactions with the user interface. In some examples, to perform the one or more interactions with the user interface, one or more processors 240 may execute the code added by the external computing system to the second software application 212B to perform the sequence of interactions with the user interface of the second software application 212B to navigate the user interface of the second software application 212B to the specific content of the second software application 212B indicated by the deep link.

In some examples, the deep link specifies a universal resource locator (URL) that is a link to a web page on a website. In some examples, the deep link is a link to an item listed by the website, and to perform the one or more interactions with the user interface of the second software application 212B, one or more processors 240 may perform the one or more interactions with the user interface of the second software application to navigate the second software application 212B to a screen of the second software application 212B that is associated with the item listed by the website.

In some examples, to perform the one or more interactions with the user interface of the second software application 212B to navigate the second software application 212B to the screen of the second software application 212B that is associated with the item listed by the website, one or more processors 240 may perform the one or more interactions with the user interface of the second software application 212B to navigate to a search field in the user interface of the second software application 212B and to input text into the search field to search for the item in the second software application 212B.

In some examples, to perform the one or more interactions with the user interface of the second software application 212B to input the text into the search field in the user interface of the second software application 212B to search for the item in the second software application 212B, one or more processors 240 may extract one or more search terms from the deep link and may perform the one or more interactions with the user interface of the second software application 212B to input the one or more search terms into the search field in the user interface of the second software application 212B to search for the item in the second software application 212B.

In some examples, to determine the second software application 212B to handle the deep link, one or more processors 240 may determine the second software application 212B to handle the deep link based at least in part on a manifest 226 associated with the second software application 212B, wherein the manifest 226 includes one or more intent filters that indicates the second software application 212B is able to support the deep link.

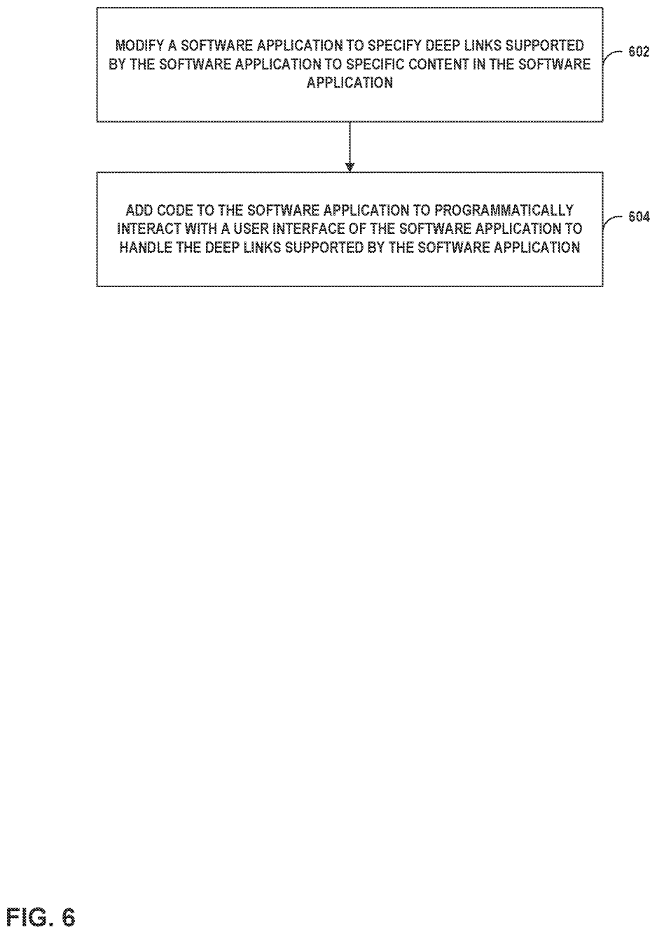

FIG. 6 is a flowchart illustrating example operations of an example computing system, in accordance with one or more aspects of the present disclosure. For purposes of illustration only, the example operations are described below within the context of computing system 320 of FIG. 3.

As shown in FIG. 6, one or more processors 340 of computing system 320 may modify a software application 312 to specify deep links supported by the software application 312 to specific content in the software application 312 (602). One or more processors 340 may add code to the software application 312 to programmatically interact with a user interface of the software application 312 to handle the deep links supported by the software application 312 (604).

In some examples, to add the code to the software application 312 to programmatically interact with the user interface of the software application 312 to handle the deep links supported by the software application 312, one or more processors 340 may add code to retrieve, from an external computing system, an indication of a sequence of interactions with the user interface to handle the deep links supported by the software application 312 and may add code to programmatically interact with the user interface according to the sequence of interactions with the user interface of the software application 312 to navigate the software application 312 to specific content of the software application 312 indicated by the deep links.

In some examples, the sequence of interactions with the user interface comprises a sequence of gestures to be performed at the user interface of the software application 312. In some examples, the sequence of interactions with the user interface comprises a sequence of interactions with the user interface to navigate the software application 312 to a search field in the user interface of the software application 312 and to input one or more search terms into the search field. In some examples, one or more processors 340 may crawl the user interface of the software application 312 to determine the sequence of interactions with the user interface that is a shortest path from a home screen of the software application 312 to the search field in the user interface of the software application 312.

In some examples, to adding the code to the software application 312 to programmatically interact with the user interface of the software application 312 to handle the deep links supported by the software application 312, one or more processors 340 may add logic to extract the one or more search terms from the deep links.

In some examples, each of the deep links specifies a universal resource locator (URL) that is a link to a web page on a website.

In some examples, to modify the software application 312 to specify that the software application 312 supports the deep links to specific content in the software application 312, one or more processors 340 may modify a manifest 326 of the software application 312 to specify that the software application 312 supports the deep links associated with one or more specified domain names.

Aspects of this disclosure include the following examples.

Example 1. A method comprising: receiving, by one or more processors and from a first software application executing at the one or more processors, a deep link; determining, by the one or more processors, a second software application to handle the deep link; in response to determining the second software application to handle the deep link, determining, by the one or more processors, one or more interactions with a user interface of the second software application to navigate the user interface of the second software application to specific content of the second software application indicated by the deep link; and performing, by the one or more processors and without user interaction, the one or more interactions with the user interface of the second software application to navigate the user interface of the second software application to the specific content of the second software application indicated by the deep link.

Example 2. The method of example 1, wherein the one or more interactions with the user interface of the second software application includes one or more gestures to be performed at the user interface of the second software application.

Example 3. The method of any of examples 1 and 2, wherein determining the one or more interactions with the user interface of the second software application to navigate the user interface of the second software application to the specific content of the second software application further comprises: retrieving, by the second software application executing at the one or more processors and from a computing system, an indication of a sequence of interactions with the user interface.

Example 4. The method of example 3, wherein retrieving the indication of the sequence of interactions with the user interface further comprises: executing, by the one or more processors, code added by an external computing system to the second software application to retrieve, from the computing system, the indication of the sequence of interactions with the user interface.

Example 5. The method of example 4, wherein performing the one or more interactions with the user interface further comprises: executing, by the one or more processors, the code added by the external computing system to the second software application to perform the sequence of interactions with the user interface of the second software application to navigate the user interface of the second software application to the specific content of the second software application indicated by the deep link.

Example 6. The method of any of examples 1-5, wherein the deep link specifies a universal resource locator (URL) that is a link to a web page on a website.

Example 7. The method of example 6, wherein the deep link is a link to an item listed by the website, and wherein performing the one or more interactions with the user interface of the second software application further comprises: performing, by the one or more processors, the one or more interactions with the user interface of the second software application to navigate the second software application to a screen of the second software application that is associated with the item listed by the website.

Example 8. The method of example 7, wherein performing the one or more interactions with the user interface of the second software application to navigate the second software application to the screen of the second software application that is associated with the item listed by the website further comprises: performing, by the one or more processors, the one or more interactions with the user interface of the second software application to navigate to a search field in the user interface of the second software application and to input text into the search field to search for the item in the second software application.

Example 9. The method of example 8, wherein performing the one or more interactions with the user interface of the second software application to input the text into the search field in the user interface of the second software application to search for the item in the second software application further comprises: extracting, by the one or more processors, one or more search terms from the deep link; and performing, by the one or more processors, the one or more interactions with the user interface of the second software application to input the one or more search terms into the search field in the user interface of the second software application to search for the item in the second software application.

Example 10. The method of any of examples 1-9, wherein determining the second software application to handle the deep link further comprises: determining, by the one or more processors, the second software application to handle the deep link based at least in part on a manifest associated with the second software application, wherein the manifest includes one or more intent filters that indicates the second software application is able to support the deep link.

Example 11. A computing device comprising: a memory that stores instructions; and one or more processors that execute the instructions to: receive, from a first software application executing at the one or more processors, a deep link; determine a second software application to handle the deep link; in response to determining the second software application to handle the deep link, determine one or more interactions with a user interface of the second software application to navigate the user interface of the second software application to specific content of the second software application indicated by the deep link; and perform, without user interaction, the one or more interactions with the user interface of the second software application to navigate the user interface of the second software application to the specific content of the second software application indicated by the deep link.

Example 12. The computing device of example 11, wherein the one or more interactions with the user interface of the second software application includes one or more gestures to be performed at the user interface of the second software application.

Example 13. The computing device of any of examples 11 and 12, wherein the one or more processors that execute the instructions to determine the one or more interactions with the user interface of the second software application to navigate the user interface of the second software application to the specific content of the second software application further execute the instructions to: retrieve, by the second software application and from a computing system, an indication of a sequence of interactions with the user interface.

Example 14. The computing device of example 13, wherein the one or more processors that execute the instructions to retrieve the indication of the sequence of interactions with the user interface further execute the instructions to: execute code added by an external computing system to the second software application to retrieve, from the computing system, the indication of the sequence of interactions with the user interface.

Example 15. The computing device of example 14, wherein the one or more processors that execute the instructions to perform the one or more interactions with the user interface further execute the instructions to: execute the code added by the external computing system to the second software application to perform the sequence of interactions with the user interface of the second software application to navigate the user interface of the second software application to the specific content of the second software application indicated by the deep link.

Example 16. The computing device of any of examples 11-15, wherein the deep link specifies a universal resource locator (URL) that is a link to a web page on a website.

Example 17. The computing device of example 16, wherein the deep link is a link to an item listed by the website, and wherein the one or more processors that execute the instructions to perform the one or more interactions with the user interface of the second software application further execute the instructions to: perform the one or more interactions with the user interface of the second software application to navigate the second software application to a screen of the second software application that is associated with the item listed by the website.

Example 18. The computing device of example 17, wherein the one or more processors that execute the instructions to perform the one or more interactions with the user interface of the second software application to navigate the second software application to the screen of the second software application that is associated with the item listed by the website further execute the instructions to: perform the one or more interactions with the user interface of the second software application to navigate to a search field in the user interface of the second software application and to input text into the search field to search for the item in the second software application.

Example 19. The computing device of example 18, wherein the one or more processors that execute the instructions to perform the one or more interactions with the user interface of the second software application to input the text into the search field in the user interface of the second software application to search for the item in the second software application further execute the instructions to: extract one or more search terms from the deep link; and perform the one or more interactions with the user interface of the second software application to input the one or more search terms into the search field in the user interface of the second software application to search for the item in the second software application.

Example 20. A non-transitory computer-readable storage medium storing instructions that, when executed, cause one or more processors of a computing device to: receive, from a first software application executing at the one or more processors, a deep link; determine a second software application to handle the deep link; in response to determining the second software application to handle the deep link, determine one or more interactions with a user interface of the second software application to navigate the user interface of the second software application to specific content of the second software application indicated by the deep link; and perform, without user interaction, the one or more interactions with the user interface of the second software application to navigate the user interface of the second software application to the specific content of the second software application indicated by the deep link.

Example 21. A method comprising: modifying, by one or more processors, a software application to specify deep links supported by the software application to specific content in the software application; and adding, by one or more processors, code to the software application to programmatically interact with a user interface of the software application to handle the deep links supported by the software application.

Example 22. The method of example 21, wherein adding the code to the software application to programmatically interact with the user interface of the software application to handle the deep links supported by the software application further comprises: adding, by the one or more processors, code to retrieve, from an external computing system, an indication of a sequence of interactions with the user interface to handle the deep links supported by the software application; and adding, by the one or more processors, code to programmatically interact with the user interface according to the sequence of interactions with the user interface of the software application to navigate the software application to specific content of the software application indicated by the deep links.

Example 23. The method of example 22, wherein the sequence of interactions with the user interface comprises a sequence of gestures to be performed at the user interface of the software application.

Example 24. The method of any of examples 22 and 23, wherein the sequence of interactions with the user interface comprises a sequence of interactions with the user interface to navigate the software application to a search field in the user interface of the software application and to input one or more search terms into the search field.

Example 25. The method of example 24, further comprising: crawling, by the one or more processors, the user interface of the software application to determine the sequence of interactions with the user interface that is a shortest path from a home screen of the software application to the search field in the user interface of the software application.

Example 26. The method of any of examples 24 and 25, wherein adding the code to the software application to programmatically interact with the user interface of the software application to handle the deep links supported by the software application further comprises: adding, by the one or more processors, logic to extract the one or more search terms from the deep links.

Example 27. The method of any of examples 21-26, wherein each of the deep links specifies a universal resource locator (URL) that is a link to a web page on a website.

Example 28. The method of any of examples 21-27, wherein modifying the software application to specify that the software application supports the deep links to specific content in the software application further comprises: modifying, by the one or more processors, a manifest of the software application to specify that the software application supports the deep links associated with one or more specified domain names.

Example 29. A computing system comprising: a memory that stores instructions; and one or more processors that execute the instructions to: modify a software application to specify deep links supported by the software application to specific content in the software application; and add code to the software application to programmatically interact with a user interface of the software application to handle the deep links supported by the software application.

Example 30. The computing system of example 29, wherein the one or more processors that execute the instructions to add the code to the software application to programmatically interact with the user interface of the software application to handle the deep links supported by the software application further execute the instructions to: add code to retrieve, from an external computing system, an indication of a sequence of interactions with the user interface to handle the deep links supported by the software application; and add code to programmatically interact with the user interface according to the sequence of interactions with the user interface of the software application to navigate the software application to specific content of the software application indicated by the deep links.

Example 31. The computing system of example 30, wherein the sequence of interactions with the user interface comprises a sequence of gestures to be performed at the user interface of the software application.

Example 32. The computing system of any of examples 30 and 31, wherein the sequence of interactions with the user interface comprises a sequence of interactions with the user interface to navigate the software application to a search field in the user interface of the software application and to input one or more search terms into the search field.

Example 33. The computing system of example 32, wherein the one or more processors further execute the instructions to: crawl the user interface of the software application to determine the sequence of interactions with the user interface that is a shortest path from a home screen of the software application to the search field in the user interface of the software application.

Example 34. The computing system of any of examples 32 and 33, wherein the one or more processors that execute the instructions to adding the code to the software application to programmatically interact with the user interface of the software application to handle the deep links supported by the software application further execute the instructions to: add logic to extract the one or more search terms from the deep links.

Example 35. The computing system of any of examples 29-34, wherein each of the deep links specifies a universal resource locator (URL) that is a link to a web page on a website.

Example 36. The computing system of any of examples 29-35, wherein the one or more processors that execute the instructions to modify the software application to specify that the software application supports the deep links to specific content in the software application further execute the instructions to: modify a manifest of the software application to specify that the software application supports the deep links associated with one or more specified domain names.

Example 37. A non-transitory computer-readable storage medium storing instructions that, when executed, cause one or more processors of a computing system to: modify a software application to specify deep links supported by the software application to specific content in the software application; and add code to the software application to programmatically interact with a user interface of the software application to handle the deep links supported by the software application.

Example 38. The non-transitory computer-readable storage medium of example 37, wherein the instructions that, when executed, cause the one or more processors to add the code to the software application to programmatically interact with the user interface of the software application to handle the deep links supported by the software application further cause the one or more processors to: add code to retrieve, from an external computing system, an indication of a sequence of interactions with the user interface to handle the deep links supported by the software application; and add code to programmatically interact with the user interface according to the sequence of interactions with the user interface of the software application to navigate the software application to specific content of the software application indicated by the deep links.

Example 39. The non-transitory computer-readable storage medium of example 38, wherein the sequence of interactions with the user interface comprises a sequence of gestures to be performed at the user interface of the software application.

Example 40. The non-transitory computer-readable storage medium of any of examples 38 and 39, wherein the sequence of interactions with the user interface comprises a sequence of interactions with the user interface to navigate the software application to a search field in the user interface of the software application and to input one or more search terms into the search field.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

1-20. (canceled)

21. A method comprising:
receiving, by one or more processors and from a first software application executing at the one or more processors, a deep link;
determining, by the one or more processors, a second software application to handle the deep link;
in response to determining the second software application to handle the deep link, determining, by the one or more processors, one or more interactions with a user interface of the second software application to navigate the user interface of the second software application to specific content of the second software application indicated by the deep link; and
performing, by the one or more processors and without user interaction, the one or more interactions with the user interface of the second software application to navigate the user interface of the second software application to the specific content of the second software application indicated by the deep link.

22. The method of claim 21, wherein the one or more interactions with the user interface of the second software application includes one or more gestures to be performed at the user interface of the second software application.

23. The method of claim 21, wherein determining the one or more interactions with the user interface of the second software application to navigate the user interface of the second software application to the specific content of the second software application further comprises:
retrieving, by the second software application executing at the one or more processors and from a computing system, an indication of a sequence of interactions with the user interface.

24. The method of claim 23, wherein retrieving the indication of the sequence of interactions with the user interface further comprises:
executing, by the one or more processors, code added by an external computing system to the second software application to retrieve, from the computing system, the indication of the sequence of interactions with the user interface.

25. The method of claim 24, wherein performing the one or more interactions with the user interface further comprises:
executing, by the one or more processors, the code added by the external computing system to the second software application to perform the sequence of interactions with the user interface of the second software application to navigate the user interface of the second software application to the specific content of the second software application indicated by the deep link.

26. The method of claim 21, wherein the deep link specifies a universal resource locator (URL) that is a link to a web page on a website.

27. The method of claim 26, wherein the deep link is a link to an item listed by the website, and wherein performing the one or more interactions with the user interface of the second software application further comprises:
performing, by the one or more processors, the one or more interactions with the user interface of the second software application to navigate the second software application to a screen of the second software application that is associated with the item listed by the website.

28. The method of claim 27, wherein performing the one or more interactions with the user interface of the second software application to navigate the second software application to the screen of the second software application that is associated with the item listed by the website further comprises:
performing, by the one or more processors, the one or more interactions with the user interface of the second software application to navigate to a search field in the user interface of the second software application and to input text into the search field to search for the item in the second software application.

29. The method of claim 28, wherein performing the one or more interactions with the user interface of the second software application to input the text into the search field in the user interface of the second software application to search for the item in the second software application further comprises:
extracting, by the one or more processors, one or more search terms from the deep link; and
performing, by the one or more processors, the one or more interactions with the user interface of the second software application to input the one or more search terms into the search field in the user interface of the second software application to search for the item in the second software application.

30. The method of claim 21, wherein determining the second software application to handle the deep link further comprises:
determining, by the one or more processors, the second software application to handle the deep link based at least in part on a manifest associated with the second software application, wherein the manifest includes one or more intent filters that indicates the second software application is able to support the deep link.

31. A computing device comprising:
a memory that stores instructions; and
one or more processors that execute the instructions to:
receive, from a first software application executing at the one or more processors, a deep link;
determine a second software application to handle the deep link;
in response to determining the second software application to handle the deep link, determine one or more interactions with a user interface of the second software application to navigate the user interface of the second software application to specific content of the second software application indicated by the deep link; and
perform, without user interaction, the one or more interactions with the user interface of the second software application to navigate the user interface of the second software application to the specific content of the second software application indicated by the deep link.

32. The computing device of claim 31, wherein the one or more interactions with the user interface of the second software application includes one or more gestures to be performed at the user interface of the second software application.

33. The computing device of claim 31, wherein the one or more processors that execute the instructions to determine the one or more interactions with the user interface of the second software application to navigate the user interface of the second software application to the specific content of the second software application further execute the instructions to:
retrieve, by the second software application and from a computing system, an indication of a sequence of interactions with the user interface.

34. The computing device of claim 33, wherein the one or more processors that execute the instructions to retrieve the indication of the sequence of interactions with the user interface further execute the instructions to:
execute code added by an external computing system to the second software application to retrieve, from the computing system, the indication of the sequence of interactions with the user interface.

35. The computing device of claim 34, wherein the one or more processors that execute the instructions to perform the one or more interactions with the user interface further execute the instructions to:
execute the code added by the external computing system to the second software application to perform the sequence of interactions with the user interface of the second software application to navigate the user interface of the second software application to the specific content of the second software application indicated by the deep link.

36. The computing device of claim 31, wherein the deep link specifies a universal resource locator (URL) that is a link to a web page on a website.

37. The computing device of claim 36, wherein the deep link is a link to an item listed by the website, and wherein the one or more processors that execute the instructions to perform the one or more interactions with the user interface of the second software application further execute the instructions to:
perform the one or more interactions with the user interface of the second software application to navigate the second software application to a screen of the second software application that is associated with the item listed by the website.

38. The computing device of claim 37, wherein the one or more processors that execute the instructions to perform the one or more interactions with the user interface of the second software application to navigate the second software application to the screen of the second software application that is associated with the item listed by the website further execute the instructions to:
perform the one or more interactions with the user interface of the second software application to navigate to a search field in the user interface of the second software application and to input text into the search field to search for the item in the second software application.

39. The computing device of claim 38, wherein the one or more processors that execute the instructions to perform the one or more interactions with the user interface of the second software application to input the text into the search field in the user interface of the second software application to search for the item in the second software application further execute the instructions to:
extract one or more search terms from the deep link; and
perform the one or more interactions with the user interface of the second software application to input the one or more search terms into the search field in the user interface of the second software application to search for the item in the second software application.

40. A non-transitory computer-readable storage medium storing instructions that, when executed, cause one or more processors of a computing device to:
receive, from a first software application executing at the one or more processors, a deep link;
determine a second software application to handle the deep link;
in response to determining the second software application to handle the deep link, determine one or more interactions with a user interface of the second software application to navigate the user interface of the second software application to specific content of the second software application indicated by the deep link; and
perform, without user interaction, the one or more interactions with the user interface of the second software application to navigate the user interface of the second software application to the specific content of the second software application indicated by the deep link.
